(19) United States
(12) Patent Application Publication
(10) Pub. No.: US 2016/0299453 A1
(43) Pub. Date: Oct. 13, 2016

(54) IMAGE FORMING APPARATUS

(71) Applicant: CANON KABUSHIKI KAISHA, Tokyo (JP)

(72) Inventors: Tomohito Ishida, Saitama-shi (JP); Shunichi Takada, Soka-shi (JP); Koichi Hashimoto, Yokohama-shi (JP); Yukio Nagase, Tokyo (JP)

(21) Appl. No.: 15/079,522

(22) Filed: Mar. 24, 2016

(30) Foreign Application Priority Data
Apr. 9, 2015 (JP) 2015-080166

(51) Int. Cl. B41J 2/385

(52) U.S. Cl. CPC G03G 15/04036

(57) ABSTRACT

An exposure unit forms an electrostatic latent image on the surface of the photoconductor by exposing a photoconductor charged by a charging unit. The electrostatic latent image includes a patterned latent image having a periodic pattern and a printing latent image according to image information to be printed. The patterned latent image includes exposed sections exposed by the exposure unit and unexposed sections less exposed than the exposed sections. Each of the exposed sections occupies 30% or more and 70% or less of an area of one period of the patterned latent image. The period of the patterned latent image in a width direction intersecting the periodic pattern is 100% or more and less than 400% of an average particle diameter of the toner.

### BACKGROUND OF THE INVENTION

1. Field of the Invention

This disclosure relates to an image forming apparatus such as a printer, a facsimile, or a copier.

2. Description of the Related Art

There is widely used an image forming apparatus including an exposing unit for exposing a photoconductor to form an electrostatic latent image according to image information, and a developing unit for developing the electrostatic latent image formed on the photoconductor into a toner image with charged toner. In general, the developing unit includes a developer bearing member bearing toner and charged at a predetermined development potential. The charged toner on the developer bearing member is selectively attracted to and adheres to an image area on the photoconductor, which is an area charged in an opposite polarity to that of the charged toner with respect to the development potential, the electrostatic latent image thereby being developed into the toner image.

A potential difference between the development potential and the potential of the image area is called a development contrast. It is known that an amount of toner applied on a unit area (toner application amount) within the image area is approximately proportional to the development contrast. That is to say, the greater the development contrast is, the thicker the toner layer of the developed image from the electrostatic latent image is. However, when developing a large image, the toner application amount varies depending on the place even when the development contrast is constant, possibly causing the unevenness of image density.

JP 2007-114755 A discloses a configuration for reducing the unevenness in image density of a halftone image using the electrostatic latent image having a periodic pattern called a mesh pattern, a screen pattern, or a dither pattern. Herein, minute electrostatic latent images are disposed according to the periodic pattern, while each minute image having an area depending on the image density.

In an example of a conventional image forming apparatus, a development contrast is set to 300 V and the average particle diameter of the toner is set to 7 μm, so that the thickness of the developed toner image is in the range of 10 to 18 μm, that is, a thickness of about two particle layers. However, as described below, it was found out that the toner application amount per unit area in the image area is sharply reduced in a case in which the development contrast is lowered less than a certain limit value (for example, 150 V). Therefore, when the development contrast is less than the limit value, the toner application amount per unit area significantly varies from place to place within the image area, which leads to the unevenness in image density.

In the configuration disclosed in the above document, toner bearing sections and blank sections are disposed in accordance with the periodic pattern within a colored area of the image. In that case, about two particle layers of toner is formed on the toner image sections by a conventional development contrast while the blank sections being kept out of toner. Thus, when the development contrast is lowered less than a certain limit value, there is a case in which the unevenness in image density occurs because of significant variation of the toner application amount per unit area within the image.

### SUMMARY OF THE INVENTION

This disclosure is to provide an image forming apparatus configured to prevent unevenness in image density within a colored area of an image even when adopting a low development contrast.

An image forming apparatus according to an aspect of this disclosure includes a photoconductor, a charging unit, an exposure unit, and a developing unit. The charging unit charges the surface of the photoconductor. The exposure unit exposes the photoconductor charged by the charging unit so as to form an electrostatic latent image which includes a printing latent image corresponding to an image information to be printed and a patterned latent image. The patterned latent image includes exposed sections exposed by the exposure unit and unexposed sections less exposed than the exposed sections. The exposed sections and the unexposed sections are disposed alternately to form a periodic pattern. The developing unit develops the electrostatic latent image formed on the photoconductor by the exposure unit with toner. Each of the exposed sections occupies 30% or more and 70% or less of an area of one period of the patterned latent image. A period of the patterned latent image in a width direction intersecting the periodic pattern is within a range of 100% or more and less than 400% of an average particle diameter of the toner.

An image forming apparatus according to another aspect of this disclosure includes a photoconductor, a charging unit, an exposure unit, and a developing unit. The charging unit charges the surface of the photoconductor. The exposure unit exposes the surface of the photoconductor charged by the charging unit so as to form an electrostatic latent image corresponding to an image information. The developing unit develops the electrostatic latent image on the photoconductor with toner. The photoconductor includes first areas configured to become conductive by being exposed by the exposure unit and second areas configured to remain approximately non-conducting upon exposed. The first areas and the second areas are disposed alternately to form a periodic pattern. Each of the first areas occupies 30% or more and 70% or less of an area of one period of the periodic pattern. A period of the periodic pattern in a width direction intersecting the periodic pattern is within a range of 100% or more and less than 400% of an average particle diameter of the toner.

Further features of the present invention will become apparent from the following description of exemplary embodiments with reference to the attached drawings.

### BRIEF DESCRIPTION OF THE DRAWINGS

FIG. 1 is a schematic diagram illustrating a configuration of an image forming apparatus.

FIG. 2 is a schematic diagram illustrating a configuration of an image forming unit.

FIG. 3 is a graph illustrating a relationship between a development contrast and a density of a toner image.

FIG. 4A is a diagram illustrating an electrostatic latent image corresponding to a character image.

FIG. 4B is an enlarged view of FIG. 4A.

FIG. 5A is a diagram illustrating an electrostatic latent image corresponding to a halftone image.

FIG. 5B is an enlarged view of FIG. 5A.

FIG. 6A is a diagram illustrating an electrostatic latent image corresponding to a screen pattern.

FIG. 6B is an enlarged view illustrating an area having a toner coverage of about 100%.

FIG. 6C is an enlarged view illustrating an area having a toner coverage of about 85%.

FIG. 6D is an enlarged view illustrating an area having a toner coverage of about 50%.

FIG. 7A is a diagram schematically illustrating a patterned latent image.

FIG. 7B is a diagram schematically illustrating toner particles bound on a photosensitive drum in an electric field formed by a patterned latent image.

FIG. 8 is a diagram schematically illustrating a positional relationship between the patterned latent image and toner particles developed according to the patterned latent image.

FIG. 9A is a graph illustrating a distribution of a surface potential of the photosensitive drum in a case where a peak-to-peak voltage is 600 V.

FIG. 9B is a graph illustrating the distribution of the surface potential of the photosensitive drum in a case where the peak-to-peak voltage is 400 V.

FIG. 9C is a graph illustrating the distribution of the surface potential of the photosensitive drum in a case where the peak-to-peak voltage is 200 V.

FIG. 10 is a graph illustrating a relationship between a development contrast and an image density, illustrating a comparison result between a plurality of apparatuses according to a first embodiment and an apparatus of a comparative example.

FIG. 11 is a schematic diagram illustrating a configuration of a scanning exposure unit.

FIG. 12 is a schematic diagram illustrating main portions of a masking exposure unit.

FIG. 13 is a perspective view of the photosensitive drum with the patterned latent image on.

FIG. 14A is a graph illustrating a distribution of charge density formed by a spot light from the scanning exposure unit.

FIG. 14B is a graph illustrating a distribution of charge density formed by the light from the masking exposure unit.

FIG. 15 is a graph illustrating a charge density distribution on the photosensitive drum with a patterned latent image on.

FIG. 16A is a graph illustrating the distribution of the surface potential of the charged photosensitive drum in the first embodiment.

FIG. 16B is a graph illustrating the distribution of the surface potential after being exposed by the masking exposure unit.

FIG. 16C is a graph illustrating an example of a distribution of the light amount emitted from the scanning exposure unit.

FIG. 16D is a graph illustrating the distribution of the surface potential after being exposed by the scanning exposure unit.

FIG. 17A is a diagram schematically illustrating a surface electric field formed by the patterned latent image.

FIG. 17B is a graph illustrating a relationship between a potential distribution and an average potential of the patterned latent image.

FIG. 18 is a diagram schematically illustrating a planer distribution of developed toner particles.

FIG. 19 is a schematic diagram illustrating a configuration of an image forming unit in a second embodiment.

FIG. 20A is a diagram illustrating a first procedure of a method of forming a photoconductive layer in the second embodiment.

FIG. 20B is a diagram illustrating a second procedure.

FIG. 20C is a diagram illustrating a third procedure.

FIG. 20D is a diagram illustrating a fourth procedure.

FIG. 20E is a diagram illustrating a fifth procedure.

FIG. 20F is a diagram illustrating a sixth procedure.

FIG. 20G is a diagram illustrating a seventh procedure.

FIG. 21A is a graph illustrating a surface potential of the photosensitive drum in the second embodiment after being charged.

FIG. 21B is a graph illustrating the surface potential in a state where an electrostatic latent image is formed by the exposure.

FIG. 22A is a diagram illustrating a first procedure of a method of forming a photoconductive layer in a third embodiment.

FIG. 22B is a diagram illustrating a second procedure.

FIG. 22C is a diagram illustrating a third procedure.

FIG. 22D is a diagram illustrating a fourth procedure.

FIG. 22E is a diagram illustrating a fifth procedure.

FIG. 23 is a graph illustrating a relationship between a development contrast and a concentration of a toner image in a fourth embodiment, illustrating a comparison result between the apparatuses according to the first and fourth embodiments and an apparatus of the comparative example.

FIG. 24 is a diagram schematically illustrating forces acting on a toner particle in a development process, in which an AC voltage is not superimposed.

FIG. 25 is a perspective view of the photosensitive drum in which a patterned latent image different from those of the first to fourth embodiments is formed.

FIG. 26A is a diagram illustrating an example of a screen pattern which is formed by a patterned latent image.

FIG. 26B is an enlarged view illustrating an area of a toner coverage of about 100%.

FIG. 26C is an enlarged view illustrating an area of a toner coverage of about 85%.

FIG. 26D is an enlarged view illustrating an area of a toner coverage of about 50%.

FIG. 27 is a diagram schematically illustrating a positional relationship between the patterned latent image shown in FIGS. 26A to 26D and toner particles developed according to the patterned latent image.

### DESCRIPTION OF THE EMBODIMENTS

Hereinafter, embodiments of this disclosure will be described in detail with reference to the drawings.

### First Embodiment

### Image Forming Apparatus

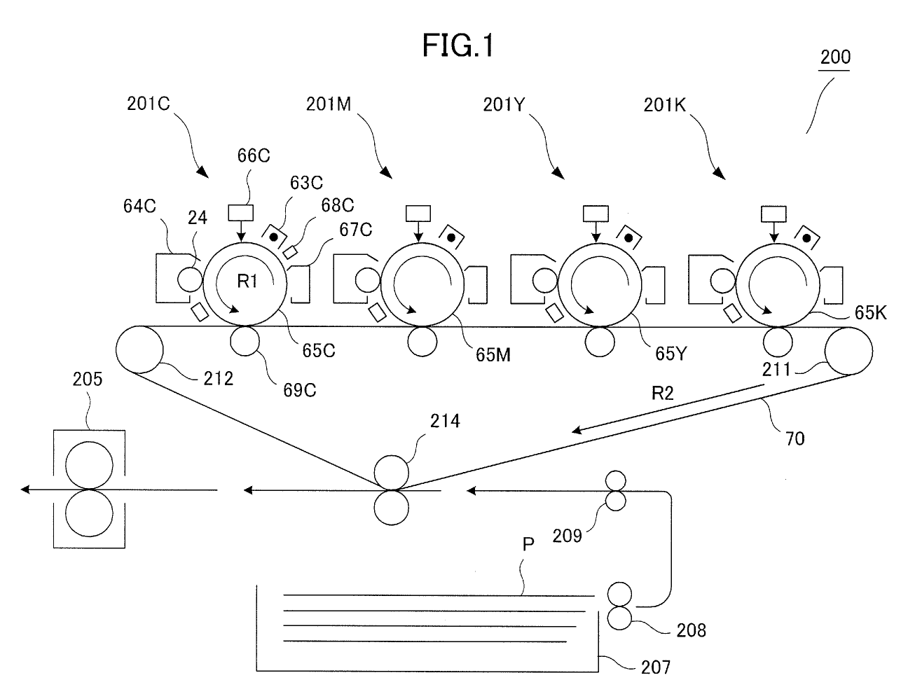

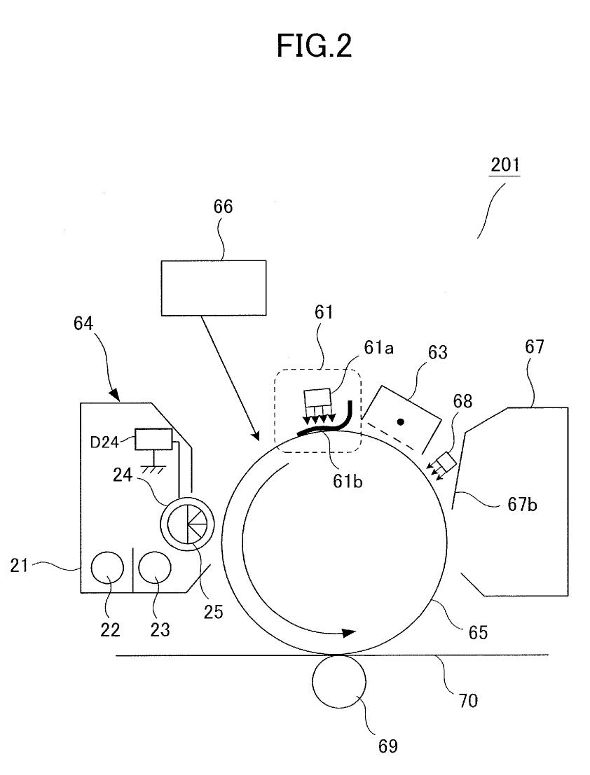

FIG. 1 is a schematic diagram illustrating a configuration of an image forming apparatus. FIG. 2 is a schematic diagram illustrating a configuration of an image forming unit. As illustrated in FIG. 1, an image forming apparatus 200 is a full-color printer of an intermediate transfer type in which image forming units 201C, 201M, 201Y, and 201K for cyan, magenta, yellow, and black, respectively, are disposed along an intermediate transfer belt 70.

In the image forming unit 201C, a cyan toner image is formed on a photosensitive drum 65C and transferred to the intermediate transfer belt 70. In the image forming unit 201M, the magenta toner image is formed in a photosensitive drum 65M and transferred to the intermediate transfer belt 70, being superimposed on a cyan toner image. In the image forming units 201Y and 201K, the yellow toner image and a black toner image are formed in photosensitive drums 65Y and 65K and similarly transferred to the intermediate transfer belt 70, being superimposed on other toner images.

A recording medium P stored in a recording medium cassette 207 is separated one by one by a separating roller 208 and stopped at a registration roller 209. The registration roller 209 feeds the recording medium P to a secondary transfer portion T2 at a timing when the toner image on the intermediate transfer belt 70 reaches the secondary transfer portion T2. The recording medium P with the transferred toner image at the secondary transfer portion T2 is heated and pressured by a fixing unit 205 to make the image fixed to its surface, and then discharged to the outside of the image forming apparatus 200. A fixing unit of the copier C7000VP (made by Canon Inc.) is employed as the fixing unit 205.

The intermediate transfer belt 70 is wound around a drive roller 211, a tension roller 212, and a secondary transfer inner roller 214, and is driven by the drive roller 211 to rotate in a direction depicted by an arrow R2. A secondary transfer roller 213 abuts on the intermediate transfer belt 70 supported by the secondary transfer inner roller 214, forming the secondary transfer portion T2.

The image forming units 201C, 201M, 201Y, and 201K have almost the same configuration except that the colors of toner used in developing units 64C, 64M, 64Y, and 64K are different. Therefore, the description hereinafter will be collectively made by excluding the tails C, M, Y, and K of the symbols for identifying the respective image forming units for the sake of avoiding a redundant description.

As illustrated in FIG. 2, the image forming unit 201 includes a corona charger 63, a scanning exposure unit 66, the developing unit 64, a transfer roller 69, and a drum cleaner 67, which are disposed around the photosensitive drum 65.

The photosensitive drum 65, which is formed a photoconductive layer of an organic photoconductor (OPC) on the outer peripheral surface of an aluminum cylinder material, is rotated in a direction of arrow R1. A peripheral speed of the photosensitive drum 65 is 300 mm/sec, for example. A diameter of the photosensitive drum 65 is 80 mm, and a film thickness of the OPC photoconductive layer is 15 μm. The corona charger 63, which serves as a charging unit, charges the surface of the photosensitive drum 65, which serves as a photoconductor. The corona charger 63 emits charged particles by corona discharging to charge the surface of the photosensitive drum 65 to the point of a predetermined dark potential VD. The scanning exposure unit 66, which serves as a first exposure unit, scans and exposes the surface of the photosensitive drum 65 according to image information to be printed, and reduces a potential of an unexposed portion down toward a light potential VL so as to form a electrostatic latent image of the image.

The developing unit 64 includes a developing sleeve 24 for carrying developer containing the toner and carrier and develops the electrostatic latent image on the photosensitive drum 65 into a toner image. The transfer roller 69 presses the intermediate transfer belt 70 to form a primary transfer portion of the toner image between the intermediate transfer belt and the photosensitive drum 65. The drum cleaner 67 slidably rubs the photosensitive drum 65 with a cleaning blade to remove residual toner which is left after the transfer. A pre-exposing unit 68 uniformly exposes the surface of the photosensitive drum 65 to eliminate the residual electrostatic latent image.

As described above, the photosensitive drum 65, which is an example of the photoconductor, is configured to be rotatable. The corona charger 63, which is an example of a charging unit, charges the surface of the photosensitive drum 65. The developing unit 64, which is an example of the developing unit, develops the electrostatic latent image formed on the photosensitive drum 65 with toner.

### Patterned Latent Image

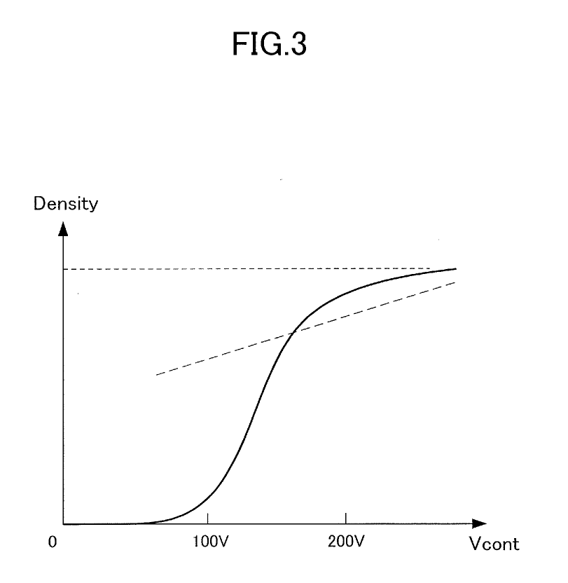

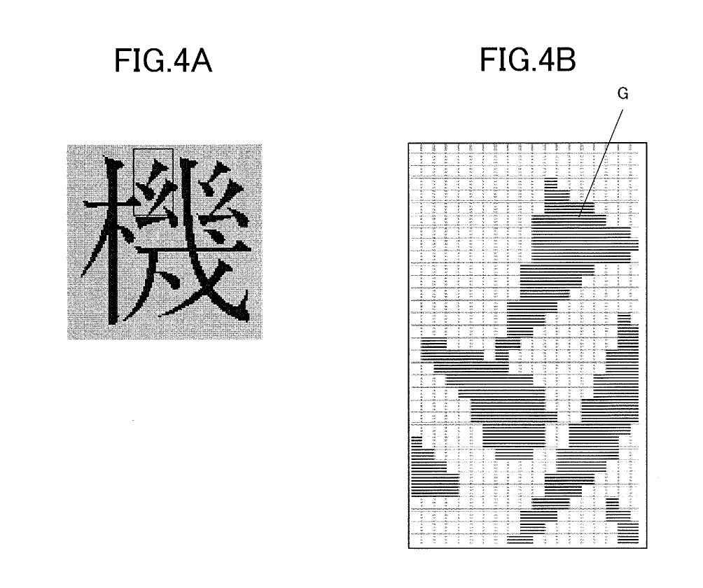

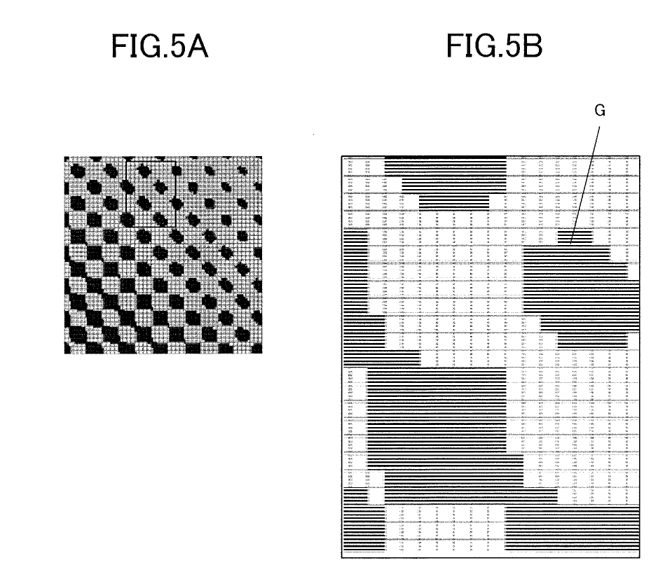

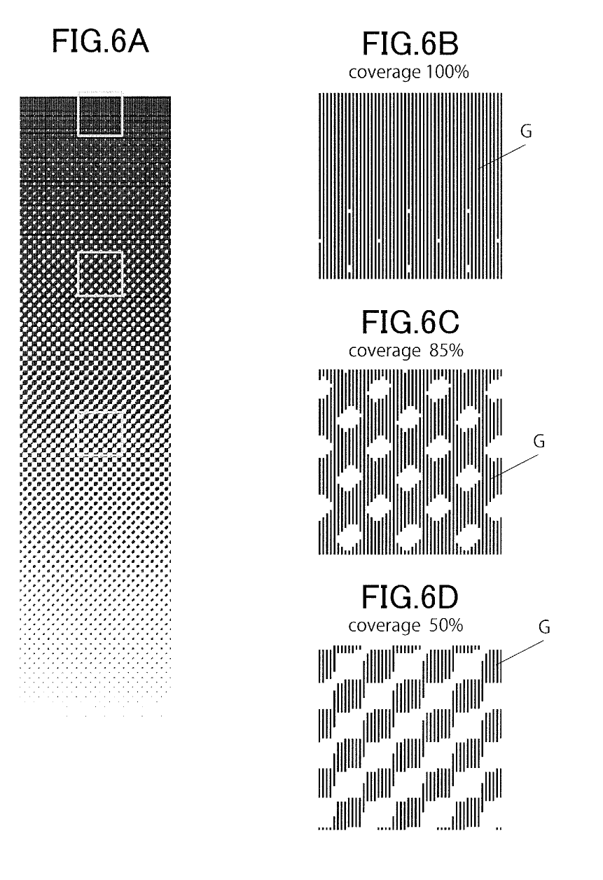

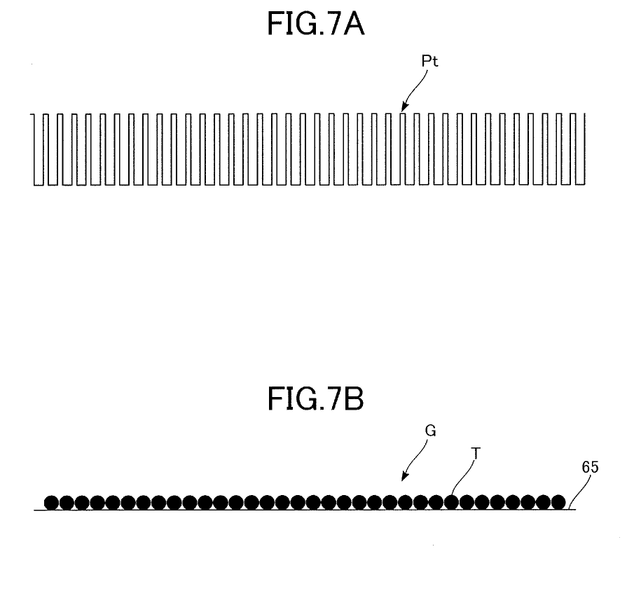

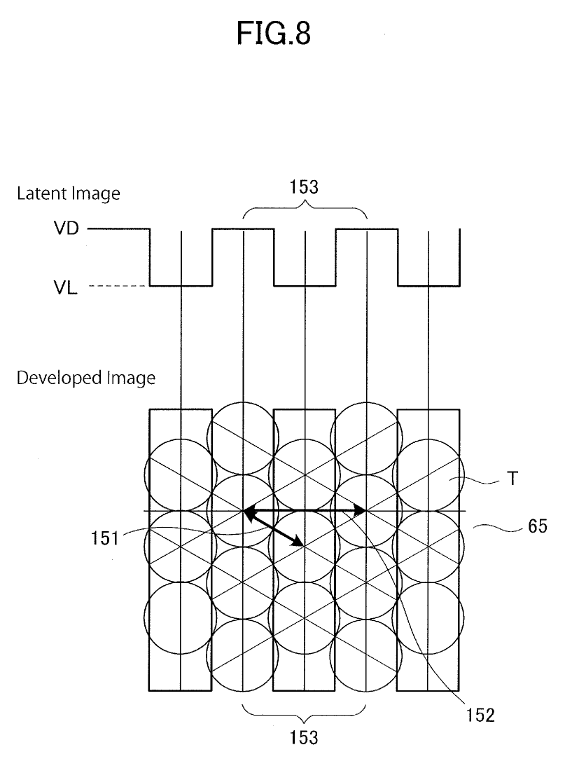

FIG. 3 is a graph illustrating a relationship between a development contrast and the density of the toner image. FIG. 4A is a diagram illustrating an electrostatic latent image corresponding to a character image, and FIG. 4B is an enlarged view of FIG. 4A. FIG. 5A illustrates an electrostatic latent image corresponding to a halftone image. FIG. 6A illustrates an electrostatic latent image corresponding to a screen pattern. FIGS. 7A and 7B illustrates a patterned latent image and toner particles bound on the photosensitive drum. FIG. 8 is a diagram schematically illustrating a positional relationship between the patterned latent image and the toner particles.

In the image forming apparatus, it is desirable that the electrostatic latent image is developed using the toner as small amount as possible for the purpose of saving the toner consumption. Conventionally, for example, the toner image of two-layer amount of toner particles (about 10 μm) is developed onto the electrostatic latent image. But it is requested that, for example, the toner image of one-layer of toner particles (about 5 μm) is developed onto the electrostatic latent image while increasing the density of pigment contained in toner as compared to the related art.

In order to develop a thinner toner image as compared to the related art, there is a need to reduce the development contrast, which is a potential difference between the potential of the developing sleeve and the potential of an image area. Herein, an image area means a part of the electrostatic latent image to be developed into a toner image. An electrostatic latent image is composed of image areas and non-image (blank) areas. The need for reducing development contrast is due to the fact that the amount of charged toner applied on the image area (toner application amount) is approximately proportional to the development contrast.

Herein, the development contrast is necessarily reduced down to about 150 V in order to make the toner image developed in the photosensitive drum 65 as thin as a single layer. However, as illustrated in FIG. 3, in the case where a development contrast Vcont is about 150 V, the density of the toner image developed from the electrostatic latent image might greatly change in response to a slight change in the development contrast, which change can be caused by a small deviation of the dark potential or the light potential. Therefore, it has been difficult to stably form a toner image that is uniform and has a high reproducibility. When the development contrast is reduced down to a level in which the developed toner image is made of an amount of toner corresponding to a single layer of toner particles, the toner application amount for the electrostatic latent image is easily deviated from place to place. In this case, the deviation of the applied toner amount per unit area might be so large that degradation in image quality of the output image can occur. As illustrated in FIG. 3, when the development contrast is reduced under a normal image forming condition for the image forming apparatus 200, an image density is lowered sharply at a development contrast Vcont of about 150 V. In this case, the stability in density of the toner image is lowered, and unevenness of density is remarkably exhibited in the output image.

In other words, in a development condition of a low development contrast is, an electric field intensity acting on the toner from the electrostatic latent image becomes small, and a non-linearity between the development contrast and the density of the toner image becomes prominent. In this case, the non-linearity is a characteristic that the development contrast and the density of the toner image show a nonlinear relationship, which is observed as a non-linear (S-shaped) curve in a graph of development contrast Vcont and image density (Density) as exemplified in FIG. 3. When the non-linearity becomes prominent, a slight change in the dark potential VD and the light potential VL of the electrostatic latent image causes a relatively great variation of the toner application amount per unit area of the toner image.

Then, in the first embodiment, as described below with reference to FIGS. 4, 5, and 6, a patterned latent image, in which exposed sections and unexposed sections are disposed alternately to form a periodic pattern, with a fineness based on a diameter of the toner particle, is formed in the electrostatic latent image on the photosensitive drum 65. By means of superimposing the patterned latent image having a periodic pattern of stripes on the electrostatic latent image of the image, the toner application amount per unit area is stabilized even when the development contrast is less than 150 V.

In the first embodiment, a patterned latent image of the stripe shape is superimposed on the electrostatic latent image of the image to be printed, so as to eliminate the non-linearity illustrated in FIG. 3. This configuration realizes an improved linearity between the development contrast Vcont and the density of the toner image as depicted by a broken line. With this configuration, the stability of outputting images, in a case where the development contrast Vcont deviates in a charging procedure or a developing procedure, is improved.

In the case of a character image as illustrated in FIGS. 4A and 4B, the entire area within the character image is an image area G, and the toner image is developed such that the toner is evenly applied to the entire image area G. In a conventional electrostatic latent image of the character image, the entire portion inside the contour of the character is charged at a uniform potential (for example, the dark potential VD. In contrast, in the first embodiment, an uneven potential distribution having a periodic pattern composed of stripes is formed in the entire region inside the contour of the character. When such an electrostatic latent image is developed into the toner image, the toner adheres to a valley portion as well as a hill portion of the potential distribution.

In the case of a halftone image as illustrated in FIGS. 5A and 5B, the entire region within each dot of the halftone image is the image area G, and the toner image is developed such that the toner is evenly applied to the entire image area G. In a conventional electrostatic latent image of the halftone image, the entire portion inside the contour of the dot is charged with a uniform potential (for example, the dark potential VD). In contrast, in the first embodiment, an uneven potential distribution having a periodic pattern composed of stripes is formed in the entire region inside the contour of each dot. When such an electrostatic latent image is developed into the toner image, the toner adheres to a valley portion as well as a hill portion of the potential distribution.

It is noted that the thin lines forming a matrix in the background of FIGS. 4A, 4B, 5A, and 5B is an auxiliary line indicating the border of a pixel (one dot) of 600 dpi including a non-developing (blank) pixel. Such lines does not affect the development process actually, but are illustrated for the comparison between the developing pixel and the blank pixel.

In the case of a screen pattern image as illustrated in FIGS. 6A, 6B, and 6C, the entire region within each dot of the screen pattern image is the image area G, and the toner image is developed such that the toner is evenly applied to the entire image area G. In a conventional electrostatic latent image of the screen pattern image, the entire portion inside the contour is charged with the uniform potential (for example, the dark potential VD). In contrast, in the first embodiment, an uneven potential distribution having a periodic pattern composed of stripes is formed in the entire region inside the contour. When such an electrostatic latent image is developed into the toner image, the toner adheres to a valley portion as well as a hill portion of the potential distribution.

As illustrated in FIG. 7A, in the first embodiment, the patterned latent image is formed to be a stripe pattern Pt of a rectangular shape at a pitch of 10 μm and a duty cycle of 50%. The toner particles T are developed almost uniformly in the entire image area G in the image area G of the electrostatic latent image, as illustrated in FIG. 7B, according to the electrostatic latent image of which the potential varies in accordance with the periodic pattern.

As illustrated in FIG. 8, the electrostatic latent image having the stripe pattern, in which hills and valleys of the potential are repeated in a width of 5 μm, generates an electric confining field having a sufficient intensity for binding the toner of which the average particle diameter is 5 μm, as described later in detail.

The pitch of the patterned latent image means a length of one cycle of (that is, the period of) the potential distribution in a periodic direction, which is a direction intersecting the stripe pattern. In other words, the pitch is a sum of a width of the stripe having a potential of the same polarity as the charged toner with respect to the development potential and a width of the stripe having a potential of the opposite polarity to the charged toner. Thus, a one-pitch length is an interval of one period (VD+VL) of stripe pattern in a width direction of the stripe pattern vertically intersecting the stripe pattern.

### Patterned Latent Image

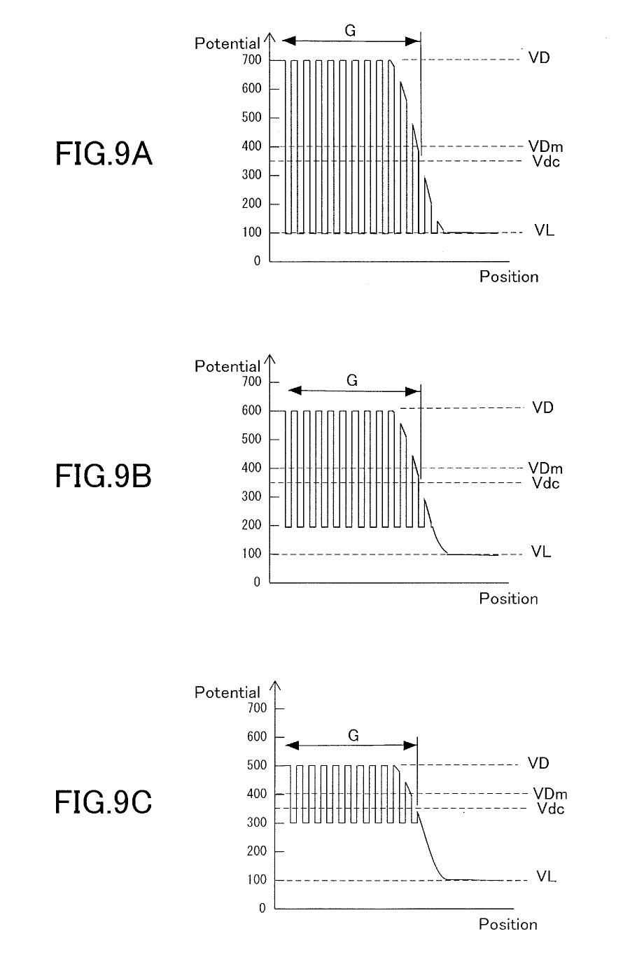

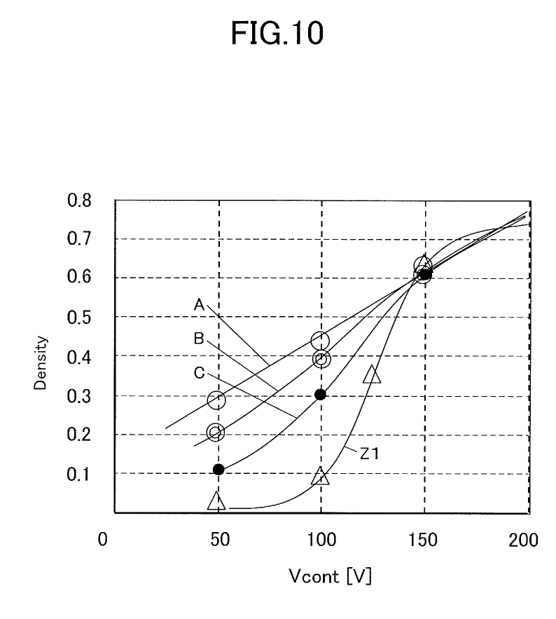

FIGS. 9A, 9B, and 9C are graphs depicting peak-to-peak voltages of the patterned latent image. In this case, the peak-to-peak voltage is the difference between the highest potential and the lowest potential, that is, the difference between a potential of the exposed section and a potential of the unexposed section, in the patterned latent image. FIG. 10 illustrates a relationship between the development contrast and the image density. FIGS. 9A, 9B, and 9C illustrate three examples in which the peak-to-peak voltages are set to 600 V for FIG. 9A, 400 V for FIG. 9B, and 200 V for FIG. 9C, respectively.

In FIGS. 9A, 9B, and 9C, the patterned latent image is drawn in a rectangular shape. In practice, since the potential of the surface of the photosensitive drum 65 is influenced by the circumambient potential, the distribution is deviated from the rectangular wave as illustrated in those graphs. Strictly speaking, an actual surface potential distribution is a potential distribution of a sine-curved shape in which the rectangular wave of the peak-to-peak voltage is somewhat rounded. Herein, the development contrast Vcont is defined as a potential difference between an average potential VDm of the patterned latent image and a development voltage Vdc.

As illustrated in FIG. 9A, the first embodiment is a normal developing system in which an exposed region according to the image information to be printed serves as a blank portion while the toner being applied on an unexposed region (in this case, a region where the patterned latent image remains) to form an image. The negatively charged toner is attached to an area (that is, the image area G) having a potential higher than the development voltage Vdc of the developing sleeve 24.

As illustrated in FIG. 9A, in a first example, the photosensitive drum 65 charged at the dark potential VD (=700 V) is exposed in the stripe pattern such that a potential of exposed portion, i.e., exposed sections, is lowered to the light potential VL (=100 V), with the patterned latent image having a peak-to-peak voltage of 600 V and an average potential VDm of 400 V being formed. In this example, the development contrast Vcont is 50 V by setting the development voltage Vdc, which is a DC component of the biasing voltage applied to the developing sleeve 24, to 350 V.

As illustrated in FIG. 9B, in a second example, the photosensitive drum 65 charged with the dark potential VD (=600 V) is exposed in the stripe pattern such that a potential of exposed portion is lowered from the potential of unexposed portion, i.e., unexposed sections, to about 200 V, with the patterned latent image having a peak-to-peak voltage of 400 V and an average potential VDm of 400 V being formed. In this example, the development contrast Vcont becomes 50 V by setting the development voltage Vdc applied to the developing sleeve 24 to 350 V.

As illustrated in FIG. 9C, in a third example, the photosensitive drum 65 charged with the dark potential VD (=500 V) is exposed in the stripe pattern such that a potential of exposed portion is lowered from the potential of unexposed portion to about 300 V, so as to form the patterned latent image having a peak-to-peak voltage of 200 V and an average potential VDm of 400 V. In the case of setting the development voltage Vdc applied to the developing sleeve 24 to 350 V, the development contrast Vcont is 50 V.

As illustrated in FIG. 10, images are formed by the image forming apparatus 200 with the patterned latent images of the first example (A), the second example (B), and the third example (C), respectively corresponding to FIGS. 9A, 9B, and 9C. Then, image density of a portion of the fixed images corresponding to the image area G are compared to each other by measuring the reflection intensity of light. In FIG. 10, a first comparative example (Z1) shows a measurement result of the fixed image which is formed on an exposure condition that the patterned latent image is not formed (see FIG. 3).

As illustrated in FIG. 10, the image density at the development contrast Vcont (=50 V) becomes higher as the peak-to-peak voltage of the patterned latent image is increased. When the peak-to-peak voltage is set to 600 V, the non-linearity in a case where the development contrast Vcont is less than 50 V is almost eliminated.

Next, images are formed with the patterned latent image at a pitch of 10 μm described above while setting the duty cycle to any one of 10%, 30%, 60%, and 80%, and are compared their image density at the development contrast Vcont (=50 V). The duty cycle is a ratio of the width of the potential area having a polarity opposed to the charged polarity of the toner with respect to one pitch width of the patterned latent image, that is, a ratio of the width of the dark potential VD with respect to a length of one pitch in FIGS. 9A, 9B, and 9C. As the recording medium, OK topcoat sheet (made by Oji Holdings Corporation) was used. As the reflection density meter, X-Rite 530 (made by X-Rite Inc.) was used for measuring the density of the fixed image. The development contrast Vcont was set to 100 V so that a single layer of toner image is formed. In the case of a duty cycle of 50%, a toner application amount on the photosensitive drum 65 of 0.32 mg/cm2 was highly evaluated.

TABLE 1

| | Duty Cycle | | | | |
|---|---|---|---|---|---|
| | 20% | 30% | 50% | 70% | 80% |
| Density | poor | good | very good | good | poor |

As listed in Table 1, when the duty cycle is set to less than 30%, the width of the stripe of the unexposed portion becomes large, and thereby the center of the unexposed portion is not attached with the toner. As a result, the image density is lowered. On the other hand, when the duty cycle exceeds 70% on a condition that the average potential VDm is 400 V, the VD is lowered consequently. As a result, an attraction force for the toner is lowered on the entire surface, and the image density is lowered. Therefore, the duty cycle is desirably set to 30% or more and 70% or less.

Next, the image densities at the development contrasts Vcont (=50 V, 100 V, 150 V) were compared while differentiating the pitch of the patterned latent image at the duty cycle of 50% into five stages of 2 μm, 5 μm, 10 μm, 20 μm, and 30 μm. The patterned latent images were formed at the same charge/exposure condition, and the patterned latent images were developed on the same development condition.

TABLE 2

| Development Contrast | 2 μm | 5 μm | 10 μm | 20 μm | 30 μm |
|---|---|---|---|---|---|
| 50 V | poor | poor | very good | poor | poor |
| 100 V | poor | good | very good | good | poor |
| 150 V | good | very good | very good | very good | good |

As listed in Table 2, the center of the unexposed portion is hardly attached with the toner as the pitch is increased, similarly to the case where the duty cycle is decreased. When the pitch becomes small, the amplitude of the potential formed in the surface becomes small by the influence of the opposite potential of the neighboring pattern. Therefore, similarly to a case where the periodic pattern is not formed, the image density falls down sharply in response to a fall of the development contrast. In this case, the results of our experiments indicate that even in a case where a pitch of 2 μm (a stripe width of 1 μm) was formed, the toner coverage of the image area was increased as compared to the electrostatic latent image of a conventional flat potential distribution without any patterned latent image, the non-linearity illustrated in FIG. 3 was thereby relieved. Therefore, a desirable value of the pitch of the patterned latent image is 100% or more and less than 400% of the average particle diameter of the toner, that is, the pitch of the patterned latent image of 5 μm or more and less than 20 μm for the average toner particle diameter of 5 μm.

Based on the above experimental result, in the first embodiment, the electrostatic latent image containing the patterned latent image is formed on the photosensitive drum 65 at the conditions of a pitch of 10 μm, a duty cycle of 50%, a peak-to-peak voltage of 600 V, and an average potential VDm (=400 V) of the patterned latent image. This configuration for the patterned latent image, matches the conditions that the pitch is 100% or more and less than 400% of the average particle diameter of the toner, and the duty cycle is 30% or more and 70% or less.

In the first embodiment, as a method of forming the electrostatic latent image containing the patterned latent image in the photosensitive drum 65, the exposure of the stripe pattern is performed using a masking exposure unit 61 (second exposure unit) to be superimposed on the exposure using the scanning exposure unit 66 according to the image information to be printed. The scanning exposure unit 66 performs the exposure in a blank portion exposing system in which an area not to be attached toner is exposed, and the developing unit 64 performs the development in a normal developing system and a dark potential developing system.

### Scanning Exposure Unit

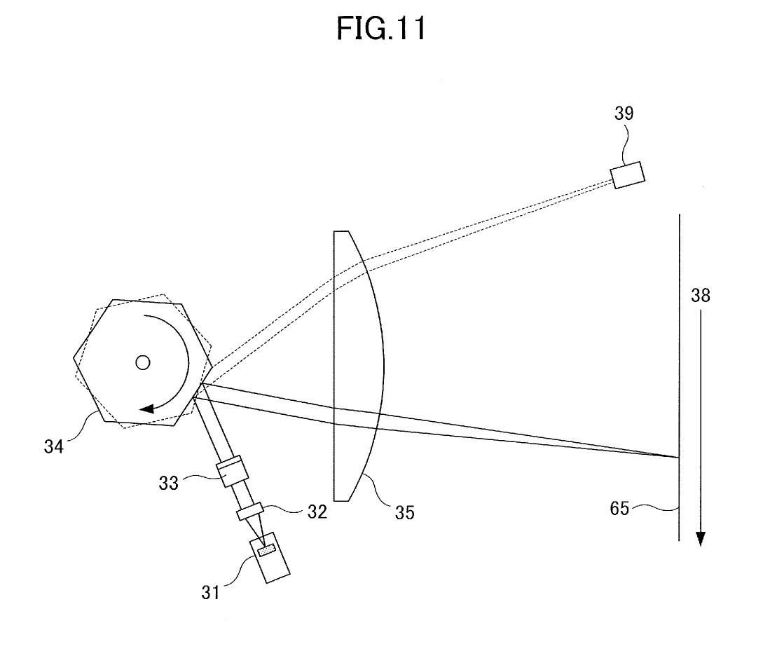

FIG. 11 is a schematic diagram illustrating a configuration of the scanning exposure unit. As illustrated in FIG. 11, the scanning exposure unit 66 deflects a laser beam emitted from a semiconductor laser 31 using a polygon mirror 34 to scan and expose the photosensitive drum 65.

The semiconductor laser 31 is driven by a light emission signal, which is generated by ON/OFF modulating of a scanning-line image signal obtained by developing the image, so as to flicker at a predetermined strength and timing. The light flux of the laser beam emitted from the semiconductor laser 31 passes through a collimator lens 32 and a cylinder lens 33, and reflected by the polygon mirror 34 which is rotated at a certain speed in the scanning process. The light flux of the laser beam passes through an fθ lens 35 and forms an image of a spot shape in the surface of the photosensitive drum 65, and moves in a main scanning direction 38 at a constant velocity.

Since a resolution of the image forming apparatus is 600 dpi, the scanning exposure unit 66 forms the electrostatic latent image at a resolution of 600 dpi. The scanning exposure unit 66 performs scanning exposure while adjusting a length of the light at a pitch of 42 μm in the main scanning direction 38 of the photosensitive drum 65. A beam spot used in the scanning exposure has a spot diameter of 50 μm in the main scanning direction 38, and a spot diameter of 60 μm in a sub-scanning direction, which is a sending direction of the photosensitive drum 65. The output of the semiconductor laser 31 is set, as illustrated in FIG. 9A, such that the light potential VL becomes 100 V at the time of the uniform exposure of the entire surface (hereinafter, referred to as a solid portion) when the dark potential VD is 700 V.

### Masking Exposure Unit

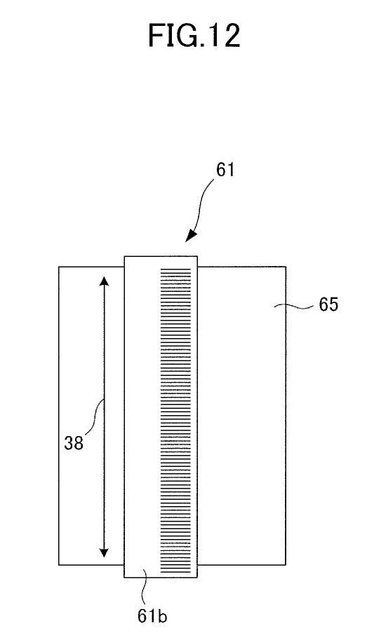

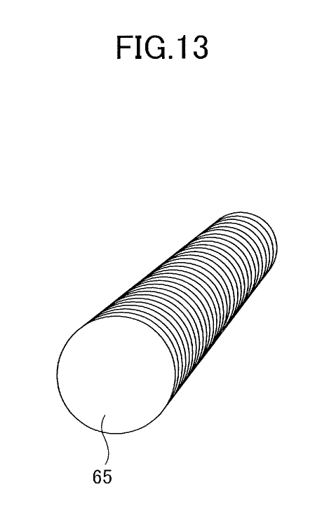

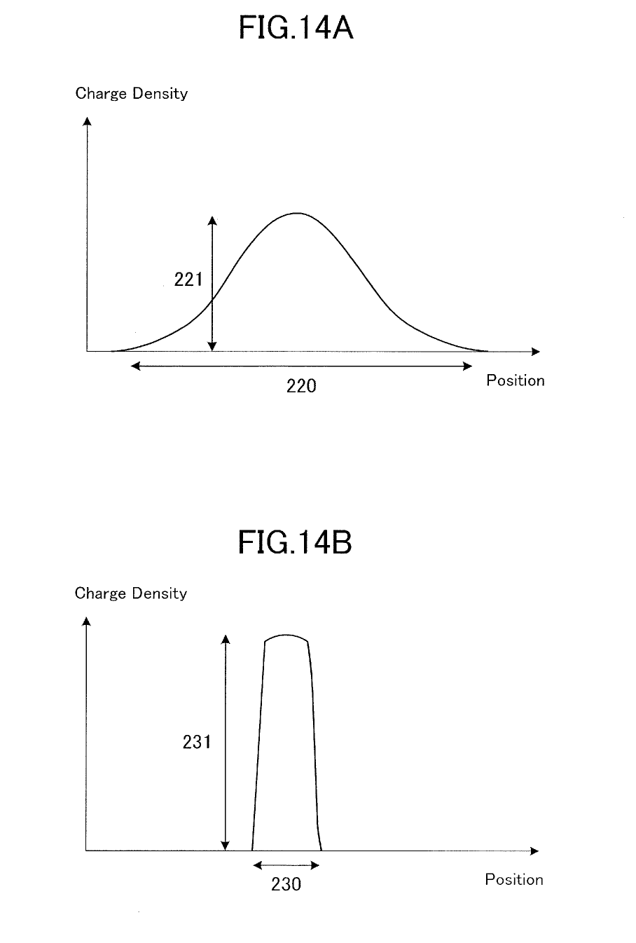

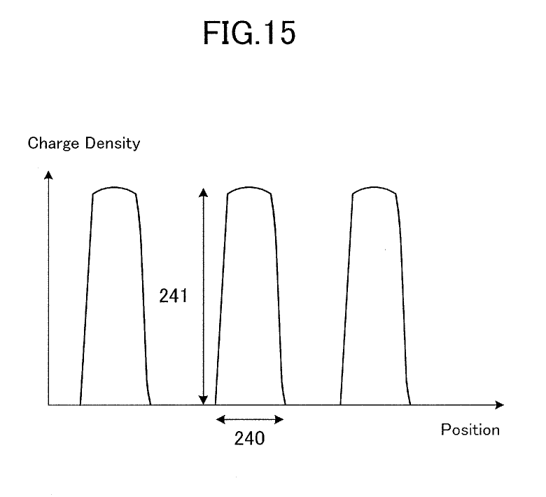

FIG. 12 is a schematic diagram illustrating main portions of the masking exposure unit 61. FIG. 13 is a perspective view of the photosensitive drum in which the patterned latent image is formed. FIG. 14A is a graph illustrating a distribution of the charge density which is formed by a spot light from the scanning exposure unit. FIG. 14B is a graph illustrating a distribution of the charge density which is formed by the light from the masking exposure unit 61. FIG. 15 is a graph illustrating a charge density distribution in the photosensitive drum in a state where the patterned latent image is formed.

As illustrated in FIG. 2, in the first embodiment, the patterned latent image having a period narrower than that of the latent image formed in the image exposure (the exposure of the scanning exposure unit 66) is formed in the photosensitive drum 65 before the exposure is performed by the scanning exposure unit 66, using the masking exposure unit 61. The patterned latent image is formed on the entire area, for forming the toner image, of the photosensitive drum 65 at such a pattern size and a pitch that the toner is uniformly developed without a gap on the photosensitive drum 65, which is an example of an image bearing member. Then, after the patterned latent image is formed on the photosensitive drum 65, the drum is exposed by the scanning exposure unit 66 to form the electrostatic latent image of the image.

It is noted that the electrostatic latent image developed by the developing unit 64 becomes equal to that of the first embodiment even when the patterned latent image is formed using the masking exposure unit 61 after the image is exposed by the scanning exposure unit 66. In other words, the same effect as the first embodiment is obtained even when the patterned latent image is formed using the masking exposure unit 61 after the image is exposed by the scanning exposure unit 66.

The masking exposure unit 61 is disposed between the exposure position of the scanning exposure unit 66 and the corona charger 63. The masking exposure unit 61 includes an LED light source 61a and an exposure mask 61b. The exposure mask 61b is disposed such that a transparent slit pattern abuts on the photosensitive drum 65.

As illustrated in FIG. 12, the exposure mask 61b, when viewed from the upside, includes a glass plate and a thin film having a periodic pattern of slits, in which translucent portions corresponding to the exposed sections and light shielding portions corresponding to the unexposed sections. The translucent portions and the light shielding portions each has a width of 5 μm and are repeatedly disposed on a surface facing the photosensitive drum 65 of the glass plate. The masking exposure unit 61 causes the LED light source 61a (see FIG. 2) to continuously emit the light so as to form the patterned latent image on the surface of the photosensitive drum 65 which is uniformly charged by the corona charger 63.

As illustrated in FIG. 13, in response to the rotation of the photosensitive drum 65, the patterned latent image in which the stripes are continuously formed in a circumferential direction and repeatedly disposed at a uniform gap in a main direction is formed in the surface of the photosensitive drum 65. In the first embodiment, the periodic pattern is a stripe pattern in which linear stripe areas (stripes) are continuously formed along a rotation direction of the photosensitive drum 65 and disposed in parallel in a direction of a rotational axis of the photosensitive drum 65.

As illustrated in FIG. 14A, the electrostatic latent image of one dot image formed by the scanning exposure unit 66 shows a Gaussian curved distribution of the charge density, which is equal to the distribution of the light amount of the beam spot of the laser beam irradiated by the scanning exposure unit 66. On the contrary, as illustrated in FIG. 14B, the period of the patterned latent image is the period of slits of the exposure mask 61b. The distribution of the light amount on the photosensitive drum 65 in the first embodiment has a profile that is a substantially rectangular shape with a half-value width of 5 μm in the longitudinal direction perpendicular to the direction of movement. The exposure amount in the slit of the masking exposure unit 61 is set to be almost the same amount as that in the beam spot when the scanning exposure unit 66 forms the electrostatic latent image of the image. It is noted that the distribution of the light amount of the beam spot and the exposure spot is measured using the laser beam profiler LEPAS (made by Hamamatsu Photonics).

The patterned latent image formed by the masking exposure unit 61 has a sharp distribution of charge density as compared to that of the electrostatic latent image formed by the scanning exposure unit 66. Since the masking exposure unit 61 shows a sharp inclination of the distribution of the light amount at the boundary with respect to the unexposed portion compared to the scanning exposure unit 66, a potential of the edge of the electrostatic image formed by the masking exposure unit 61 is more sharply changed than the electrostatic latent image formed by the scanning exposure unit 66. In other words, the masking exposure unit 61 which uses the exposure spot of the distribution of the light amount sharper than that of the scanning exposure unit 66 forms the patterned latent image of which the charge density distribution is sharper than that formed by the scanning exposure unit 66.

The fact that the charge density distribution is sharp means that an aspect ratio of the charge density with respect to the area where the charges of the electrostatic patterned latent image are present is high. A ratio (the aspect ratio) of a charge density 231 with respect to an area 230 where the charges are present in FIG. 14B is higher than a ratio (the aspect ratio) of a charge density 221 with respect to an area 220 where the charges are present in FIG. 14A. The sharp patterned latent image increases a binding force of the toner particles in the exposure area of the stripe shape, so that the stability of the image density is increased with respect to the variation in the development contrast.

As illustrated in FIG. 15, in the patterned latent image formed by the masking exposure unit 61, the charge density distribution is formed at a repetition period corresponding to a slit pitch of the exposure mask 61b. At this time, an area 240 where the charges are present and a charge density 241 are defined with respect to the charge density distribution of one repetition unit. When the charge density pattern of the electrostatic latent image is formed by light emission, the area where the charges are present corresponds to an exposure area, and the charge density corresponds to an exposure intensity.

### Exposure Procedure

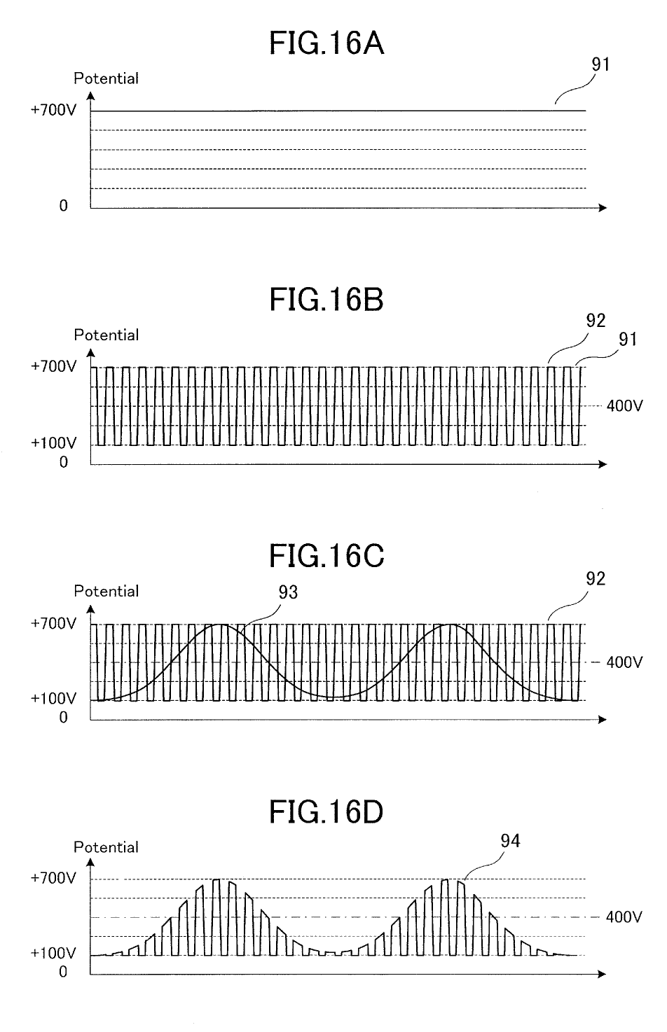

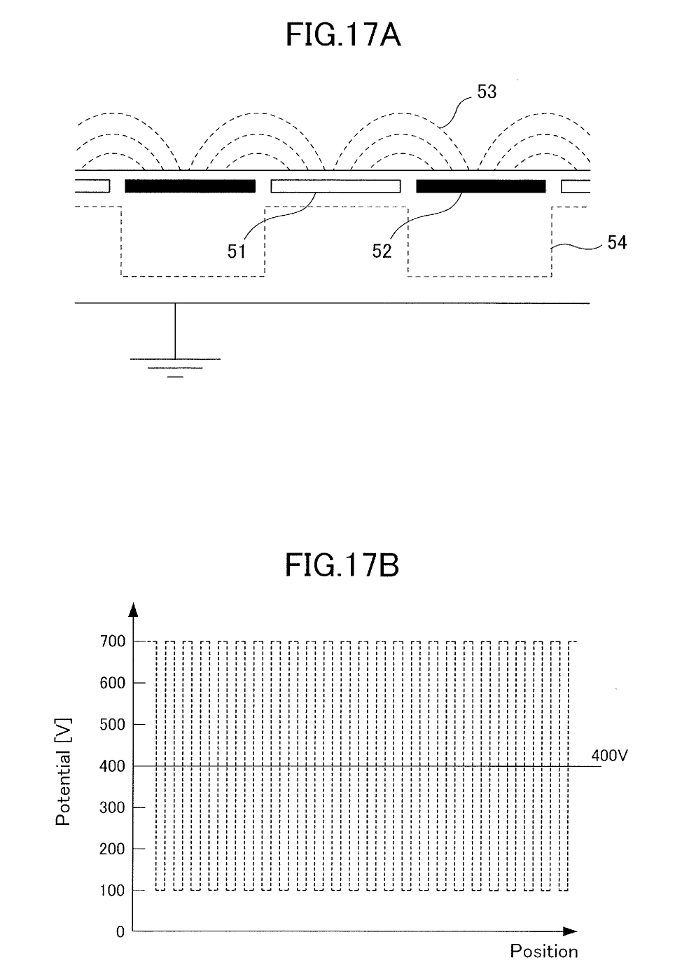

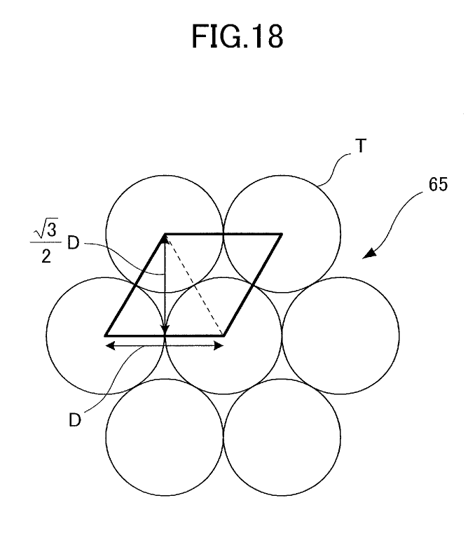

FIGS. 16A to 16D illustrate the exposing process of the photosensitive drum in the first embodiment. FIGS. 17A and 17B schematically illustrate a surface electric field which is formed by the patterned latent image. FIG. 18 is a diagram schematically illustrating a planer distribution of developed toner particles.

As illustrated in FIG. 16A, the corona charger 63 forms an uniformly charged surface 91 of about +700 V in the surface of the photosensitive drum 65. As illustrated in FIG. 16B, the masking exposure unit 61 forms the patterned latent image on the entire surface of the charged surface 91. Since the exposure amount is set as described above (the first example), a patterned latent image 92 is formed in which the potential of the exposure area is reduced to +100 V, and alternately repeated between +700 V and +100 V. The average potential of the charged surface 91 having the patterned latent image 92 is +400 V.

As illustrated in FIG. 16C, the scanning exposure unit 66 scans to expose the photosensitive drum 65 so as to superimpose an electrostatic latent image 93 of the image (that is, a printing latent image to be printed into a toner image) on the patterned latent image 92. As a result, as illustrated in FIG. 16D, the patterned latent image is combined to the entire electrostatic latent image of the image so as to form an electrostatic latent image distribution 94.

As illustrated in FIG. 17A, the patterned latent image is formed on the surface of the photosensitive drum 65. When minute charge patterns 51 and 52 are present on the surface of the photosensitive drum 65, an electric flux line 53 closing the surface of the photosensitive drum 65 is formed to assert a force on the surface of the photosensitive drum 65 so as to bind the toner particles. In other words, it is estimated that the binding force is asserted on the toner particles T by an electric field formed between the stripe of the dark potential VD and the stripe of the light potential VL which are alternately disposed. Hereinafter, the electric field is called as an electric confining field.

Then, an electric field in the horizontal direction formed between the neighboring charge patterns 51 and 52 causes the toner particles to move along the surface of the photosensitive drum 65. Therefore, it is considered that the electric field in the horizontal direction encourages a single-layered toner image to be uniformly formed substantially in the highest density arrangement without a gap as illustrated in FIG. 18.

As illustrated in FIG. 17B, the average potential of the charged surface 91 which is not exposed by the scanning exposure unit 66 is +400 V. On the other hand, the average potential of the exposure area which is exposed by the scanning exposure unit 66 becomes+100 V. At a duty cycle of 50%, a width of the dark potential VD of 700 V and a width of the light potential VL of 100 V are equalized to form the patterned latent image of an average potential of 400 V.

As described above, the masking exposure unit 61, which is an example of a first exposure unit, exposes the surface of the charged photosensitive drum 65 and forms the patterned latent image in which the exposed sections exposed by the masking exposure unit 61 and the unexposed sections not exposed (less exposed than the exposed section, at least) are alternately and periodically formed. The scanning exposure unit 66, which is an example of a second exposure unit, exposes the surface of the photosensitive drum 65, which is an example of the photoconductor, according to the image information. The developing unit 64, which is an example of the developing unit, supplies the toner to the electrostatic latent image formed by superimposing the patterned latent image and the latent image according to the image information, respectively formed on the photosensitive drum 65 by the masking exposure unit 61 and the scanning exposure unit 66, so as to develop the toner image.

### Development Procedure

A development container 21 of the developing unit 64 illustrated in FIG. 2 is filled with a developer which includes the toner and the carrier. A stirring chamber 26 and a developing chamber 27 of the development container 21 form circulation path for the developer. A stirring screw 22 is disposed in the stirring chamber 26, and a developing screw 23 is disposed in the developing chamber 27. The stirring screw 22 and the developing screw 23 circulate the developer in the stirring chamber 26 and the developing chamber 27 to rub and charge the toner and the carrier.

The developing sleeve 24 is disposed in an opening facing the photosensitive drum 65 of the development container 21 and rotated at a high speed. A non-rotatable magnetic roller 25 is disposed in the developing sleeve 24. The developing sleeve 24 is rotated while carrying the charged developer, forms magnetic naps of the developer to be rubbed with the photosensitive drum 65.

The electrostatic latent image in which the patterned latent image is combined in the entirety of the electrostatic latent image of the image is developed into the toner image by the developing sleeve 24 on which the two-component developer containing negatively-charged non-magnetic toner and positively-charged magnetic carrier is carried. The developer is a cyan developer for the copier C7000VP (made by Cannon Inc.).

As illustrated in FIG. 9A, the toner moves to the electrostatic latent image of the photosensitive drum 65 and the toner image is developed by applying the development voltage, which contains an AC voltage and a DC voltage Vdc superimposed on each other, the DC voltage being an intermediate potential between the average potential VDm and the dark potential VD toward the developing sleeve 24. With respect to the developing sleeve 24, the image area G is considered as the surface of the average potential VDm. Therefore, the potential difference between the average potential VDm and the DC voltage Vdc becomes the development contrast Vcont, so that the density (the toner application amount) of the toner image developed to the electrostatic latent image is defined. In addition, the fog removal contrast, which is defined as the potential difference between the light potential VL and the DC voltage Vdc, determines a margin indicating that the toner image is not attached to the blank portion of the image.

Specifically, an oscillation voltage of the rectangular wave containing the AC voltage (a frequency of 6 kHz and an amplitude of 1.5 kV) superimposed on the DC voltage Vdc is applied as the development voltage to the developing sleeve 24. As illustrated in FIG. 9A, the average potential of the unexposed sections of the photosensitive drum 65 is +400 V, and the potential of the exposed sections is +100 V. When the DC voltage Vdc is set to +250 V, the development contrast Vcont which is the potential difference between the DC voltage Vdc and the unexposed sections of the photosensitive drum 65 becomes 400−250=150 [V]. Therefore, the single-layered toner image is formed on the electrostatic latent image of the photosensitive drum 65 uniformly and substantially in the highest density arrangement without a gap. A method of calculating the toner application amount at this time will be described. In the first embodiment, the developing unit 64 uses the toner having an average particle diameter of 4 μm or more and less than 8 μm in a developer bearing member charged at the development potential. The development contrast which is the potential difference between the average potential of the image area of the photosensitive drum 65 and the development potential is set to 150 V or less.

The voltage applied to the developing sleeve 24 by a power source D24 is a voltage as high as a single-layered toner is carried on an area corresponding to the image of the electrostatic latent image formed on the photosensitive drum 65. Therefore, a toner disposition amount difference between the stripe area of the dark potential VD and the stripe area of the unexposed portion of the masking exposure unit 61 becomes small, so that it is considered that the entire electrostatic latent image of the developed image is covered by almost the single-layered toner.

As illustrated in FIG. 18, it is assumed that the spherical toner particles having an average particle diameter D [μm] are distributed substantially in the highest density arrangement covering the image area of the electrostatic latent image. At this time, a toner disposition amount Mt [mg/cm2] in the highest density arrangement can be obtained based on a diamond-shaped area S [μmt] surrounded by a bold line which is a repetition unit, a toner volume Vo [μm3] contained in a diamond-shaped area, and a toner density ρ [g/cm3].

$${S}_{•} = \frac{\sqrt{3}}{2} {D}^{2} [ {µm}^{2} ] , {V}_{0} = {π ( \frac{D}{2} )}^{2} [ {µm}^{3} ] , M t = \frac{ρ π D}{3 \sqrt{3}} * {10}^{- 1} [ mg \text{/} {cm}^{2} ] \qquad Equation 1$$

In the calculation, the toner density p of the toner is set to 1 [g/cm3]. In this time, the toner disposition amount Mt for forming the single-layered toner on the photosensitive drum 65 is calculated as 0.32 mg/cm2 based on the used toner particle diameter. As described above, the single-layered toner image is stably formed on the photosensitive drum 65 substantially in the highest density arrangement having few gaps even when the development contrast Vcont varies. Even in such a low application condition that the toner layer after the development corresponds to about a single layer, the stability against the potential variation of the solid image portion can be improved without degrading chroma.

In the first embodiment, each of the exposed sections occupies 30% or more and 70% or less of an area of one period of the patterned latent image, and the periodic pattern of the patterned latent image has a period of 100% or more and less than 400% of an average particle diameter of the toner in a direction intersecting the periodic pattern. With this configuration, the unexposed section, on which the toner does not attach in nature, between the exposed sections is also attached with the toner by an amount almost equal to that of the unexposed sections.

In the first embodiment, the masking exposure unit 61 irradiates the surface of the rotating photosensitive drum 65 with the light through the exposure mask 61b, which is an example of a light shielding member having the translucent portions according to the patterned latent image. Therefore, it is possible to form a minute patterned latent image which has been difficult to be realized in the scanning of the laser beam.

In the first embodiment, since the electrostatic latent image of the image is patterned in the stripe shape, a deviation of the toner application amount at every place of the toner image in a range of the development contrast less than 150 V is alleviated as compared to the case of having no pattern in the stripe shape.

Therefore, using the range of the development contrast less than 150 V, it is possible to more stably form the single-layered toner image which has been difficult to stably secure the development density in the certain conventional image formation where no patterned latent image is used.

Therefore, in the first embodiment, it is possible to improve the stability of the image density against the variation in the development contrast without degrading the chroma of the image even on a condition of a toner disposition amount as low as the toner layer after the development can barely cover an image area. In other words, since the toner particles are arranged at a minute pitch without a gap in the toner image developed with the electrostatic latent image of the image, the degradation of the chroma of the image hardly occurs.

It is noted that the first embodiment has been described to include the scanning exposure unit 66, which serves as the first exposure unit forming the latent image on the photosensitive drum according to the image information to be printed, and the masking exposure unit 61, which serves as the second exposure unit forming the patterned latent image on the photosensitive drum. In other words, in this embodiment, an exposure unit 60 is composed of the first exposure unit equipped with the semiconductor laser 31 serving as a first light source and the second exposure unit equipped with the LED light source 61a serving as a second light source. However, the exposure unit is not limited to the above configuration, but any configuration may be employed as long as that exposure unit is capable of forming a electrostatic latent image in which a latent image according to the image information and a periodic patterned latent image are superimposed on each other. For example, such a configuration is applicable that a light shielding member similar to the exposure mask 61b partially blocks the light passing through the fθ lens 35 of the scanning exposure unit 66. This kind of configuration also enables to form a electrostatic latent image in which the latent image according to the image information and the patterned latent image are superimposed on each other. In this case, in order to reduce blurring (a reduction of the aspect ratio) of the patterned latent image caused by diffraction, the light shielding member is desirably disposed as close to the surface of the photoconductor as possible.

In the second example, the influence of the duty cycle of the patterned latent image and the pitch between the neighboring patterns is similar to the examples shown by Tables 1 and 2. By the way, the first embodiment is described as the normal development system, the following second embodiment will be described as a reversal development system, being different in polarity from the first embodiment. However, the relationship between the distribution of the electrostatic latent image and the force of the electric field formed by the electrostatic latent image operating on the toner is similar to each other. Therefore, even in the second embodiment, the duty cycle of a light area as the image portion of the patterned latent image is desirably 30% or more and less than 70%. In addition, the pitch of the patterned latent image is desirably 100% or more and less than 400% of the average particle diameter of the toner. In other words, in the case where the average particle diameter of the toner is 5 μm, the pitch of the patterned latent image is desirably 5 μm or more and less than 20 μm.

### Second Embodiment

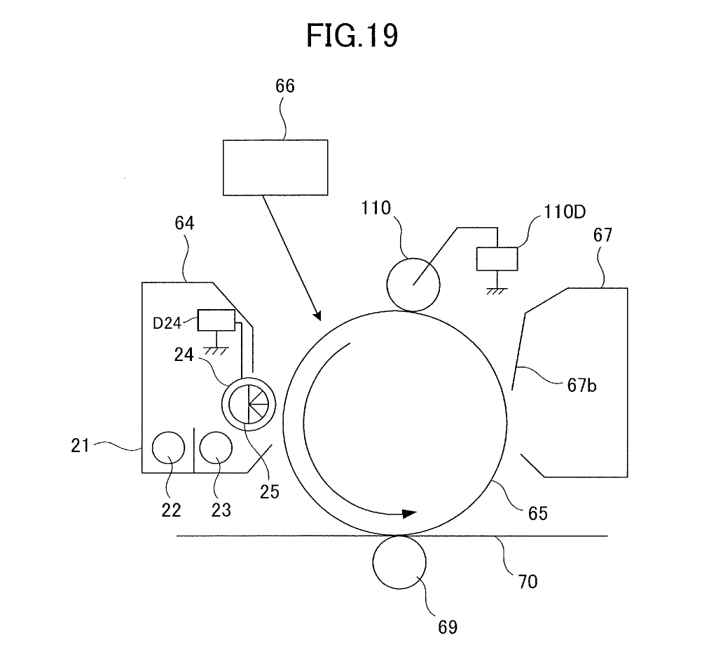

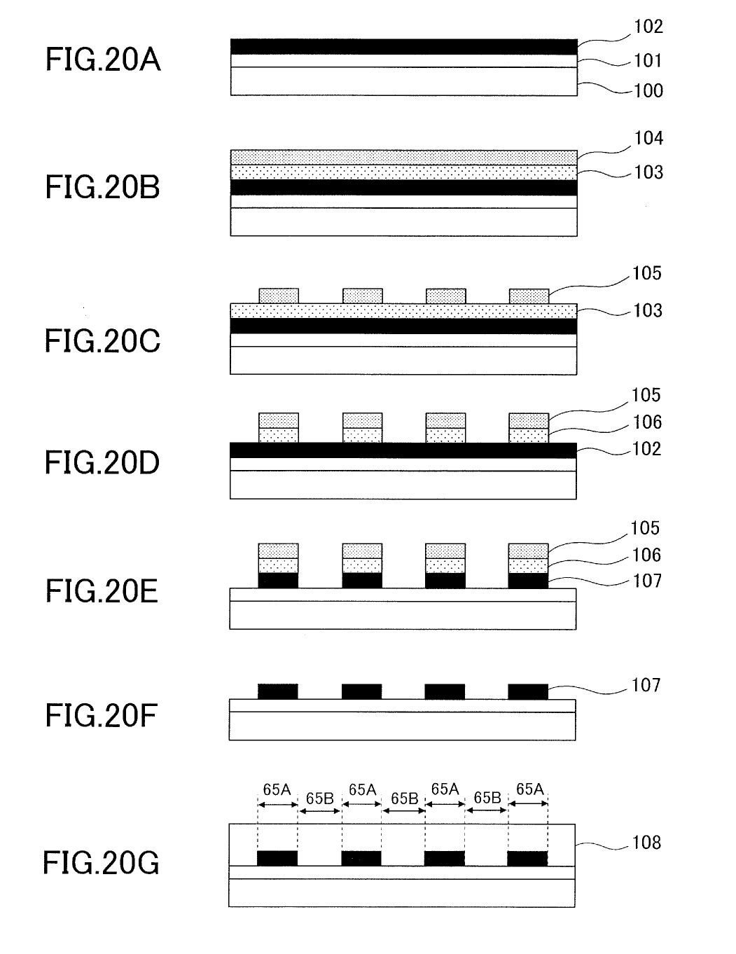

FIG. 19 is a schematic diagram illustrating a configuration of an image forming unit in a second embodiment. FIGS. 20A to 20F illustrate the respective procedures of a method of forming the photoconductive layer in the second embodiment. In the first embodiment, the electrostatic latent image of the image patterned in the stripe shape is formed using the masking exposure unit 61 (see FIGS. 2, and 4A to 6D). In this regard, in the second embodiment, as illustrated in FIGS. 20A to 20G, the photoconductive layer (107) is patterned in the stripe shape according to the periodic pattern in advance, so that the electrostatic latent image of the image patterned in the stripe shape is formed automatically. In the second embodiment, the components other than the photosensitive drum 65 and a charging roller 110 are the same as those of the first embodiment, in FIG. 19, the same components as those of the first embodiment will be denoted by the same reference numerals and signs in FIG. 2 and the redundant description will be omitted.

Similarly to the first embodiment illustrated in FIG. 13, in the second embodiment, the minute pattern of the stripe shape is formed with high density in parallel to the photoconductive layer of the photosensitive drum 65. On the photosensitive drum 65 are formed areas (first areas) configured to be reduced to the light potential VL by the exposure and areas (second areas) configured not to be reduced to the light potential VL even by the exposure. These areas are alternately disposed in the peripheral surface of the photosensitive drum 65 in the stripe shape. Therefore, as illustrated in FIG. 19, the electrostatic latent image having the patterned latent image as illustrated in FIGS. 4, 5, and 6 is automatically formed in the photosensitive drum 65 in accordance with a charging process of the photosensitive drum 65 by the charging roller 110 and the exposure of the image by the scanning exposure unit 66. In the second embodiment, a photoconductive portion and a non-photoconductive portion are alternately formed in the entire surface of the photosensitive drum 65 according to the following processes.

As illustrated in FIG. 20A, first, an insulating layer 101 and a photoconductive layer 102 are stacked on an aluminum substrate 100. As illustrated in FIG. 20B, an aluminum layer 103 is deposited on the photoconductive layer 102 by 100 nm, and a positive resist layer 104 is coated on the aluminum layer 103 by 5 μm.

As illustrated in FIG. 20C, a positive resist layer 104 is exposed and developed using a line-and-space photomask of 5 μm/5 μm, so that a resist pattern 105 is formed on the aluminum layer 103. As illustrated in FIG. 20D, an aluminum layer 106 exposed from the resist pattern 105 is etched.

As illustrated in FIG. 20E, an exposed photoconductive layer 107 is patterned by a reactive ion etching using oxygen plasma. As illustrated in FIG. 20F, after the patterning, the resist pattern 105 and the aluminum layer 103 are selectively removed. As illustrated in FIG. 20G, a charge transfer layer 108 is coated on the photoconductive layer 107 by 15 μm through a dipping method. Through the processes as described here, first areas 65A, which serve as first portions configured to become conductive by the exposure, and second areas 65B, which serve as second portions configured to remain substantially non-conducting, are formed on the photosensitive drum 65.

### Charging Roller

By the way, in the second embodiment, since there is a portion having no charge generation layer on the photosensitive drum 65, unlike the first embodiment, a charge history of the photosensitive drum 65 cannot be erased using the pre-exposing unit 68 (FIG. 2). Thus, in the second embodiment, as illustrated in FIG. 19, the previous charge history is erased using the charging roller 110 in accordance with the charging process of the photosensitive drum 65.

A charge power source 110D applies the development voltage containing an AC voltage Vac superimposed on the DC voltage Vdc to the charging roller 110 to remove the electrostatic latent image left on the photosensitive drum 65, so that an uniformly charged surface unaffected by the charge history is formed. In the second embodiment, a charging voltage containing the rectangular wave AC voltage Vac (1 kHz, 800 V) superimposed on the DC voltage Vdc (−700 V) is applied to the charging roller 110 using the charging roller 110 of C5035 copier (made by Cannon Inc.). Then, a dark potential VD of −700 V is obtained.

### Image Exposure

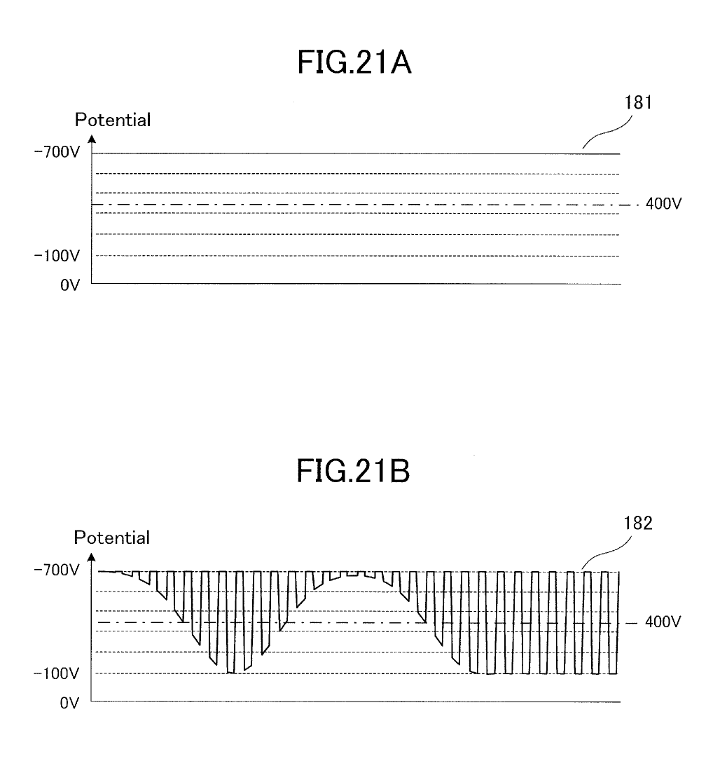

FIGS. 21A and 21B illustrate the surface potential of the photosensitive drum in the second embodiment. In the second embodiment, the patterned latent image according to the processed pattern of the photosensitive drum 65 is formed on an irradiated portion with the light. Then, the image exposure for forming the electrostatic latent image of the image adopts an image exposure system in which the image area is exposed, a reversal development system, and a light potential developing system. As described above, the scanning exposure unit 66 performs the scanning exposure by using a laser spot having a Gaussian intensity distribution of 50 μm in the main scanning direction and 60 μm in the sub-scanning direction and forms the electrostatic latent image of the image.

As illustrated in FIG. 21A referring to FIG. 14, the charging voltage is applied to the charging roller 110 to form a charged surface 181 uniformly charged by the dark potential VD (=−700 V) in the photosensitive drum 65. Thereafter, when the scanning exposure unit 66 performs an ordinary scanning exposure on the insulating layer 101 to form the electrostatic latent image of the image, an electrostatic latent image 182 of the image containing the patterned latent image is automatically formed on the scanning exposure area as illustrated in FIG. 21B. The output of the laser beam of the scanning exposure unit 66 is set to a light amount such that the potential of the area corresponds to the patterned photoconductive portion becomes 100 V.

Since a photoconductive area and a non-photoconductive area are patterned in the photoconductive layer of the photosensitive drum 65, the potential of the photoconductive area is reduced to 100 V at maximum, and the potential of the non-photoconductive area remains at the dark potential VD=−700 V. As a result, the average potential of the patterned latent image which is not exposed by the scanning exposure unit 66 becomes −400 V. In the second embodiment, since the photoconductive layer is removed according to the periodic pattern, the electrostatic latent image of the image in which the patterned latent image is disposed is automatically formed in the entire image area after an ordinary exposure according to the image information by the scanning exposure unit 66.

### Development Condition

In the second embodiment, the electrostatic latent image of the image containing the patterned latent image formed on the photosensitive drum 65 is reversely developed. As the developer, the cyan developer of the copier C7000VP (made by Cannon Inc.) containing the non-magnetic toner charged at the negative polarity and the magnetic carrier charged at the positive polarity is used.

The oscillation voltage containing the AC voltage Vac of the rectangular wave (a frequency of 6 kHz, an amplitude of 1.5 kV) superimposed on the DC voltage Vdc (=−550 V) is applied to the developing sleeve 24 of the developing unit 64. In the electrostatic latent image containing the patterned latent image, the average potential VDm of the image area is set to −400 V, and the average potential of the non-image area is set to −700 V. The development contrast Vcont which is a potential difference between the DC voltage Vdc (=−550 V) and the average potential VDm (=−400 V) of the image area is 150 V.

As described above, the scanning exposure unit 66, which is an example of the exposing unit, exposes the surface of the photosensitive drum 65 charged by the corona charger 63 according to the image information so as to form the electrostatic latent image. The photosensitive drum 65 includes first areas 65A, i.e., first portions configured to be conductive and be reduced in its potential by the exposure, and second areas 65B, i.e., second portions configured to be substantially not conductive and not reduced in its potential by the exposure. The first and second areas 65A and 65B are alternately and formed in accordance with a periodic pattern (See FIG. 20G). The periodic pattern is a stripe pattern in which line-shaped areas (stripes) are disposed in parallel, and the areas continuously formed along the rotation direction of the photosensitive drum 65 are disposed in the direction of the rotational axis of the photosensitive drum 65.

In the second embodiment, each of the first portions occupies 30% or more and 70% or less of an area of one period of the periodic pattern, and the periodic pattern has a period of 100% or more and less than 400% of an average particle diameter of the toner in a direction intersecting the periodic pattern. Therefore, the second areas 65B, on which the toner is not applied in nature, between the first areas 65A (unexposed portions) are also attached with a sufficient amount of the toner.

In the second embodiment, the photoconductive layer of which the surface charges are reduced by the exposure is formed in the photosensitive drum 65 according to the periodic pattern. Therefore, there is no need to equip the masking exposure unit 61 of the first embodiment. Then the same effect as that of the first embodiment is obtained only by adding a few procedures to a conventional forming procedure of photosensitive drums. Even on a low application condition such that the toner layer after the development corresponds to about a single layer, the image is stably formed against the variation in the development contrast and without degrading chroma.

### Third Embodiment

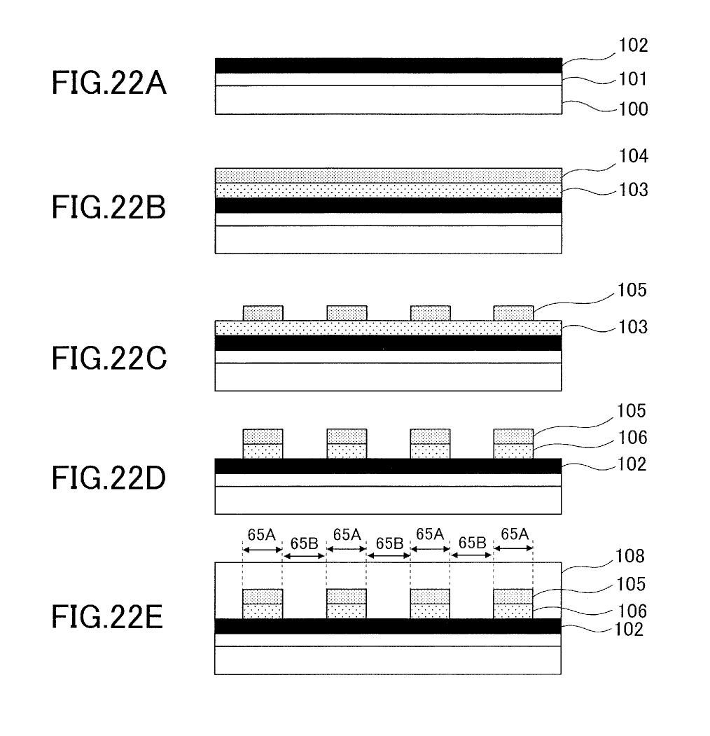

FIGS. 22A to 22E illustrate the respective procedures of a method of forming a photoconductive layer in a third embodiment. In the second embodiment, the periodic pattern is formed in the photosensitive drum 65 to form the photoconductive layer. In this regard, in the photosensitive drum 65 of the third embodiment, the photoconductive layer, which is configured to be conductive and dissipate the surface charge by the exposure, is blocked by the light blocking layer from the light according to the periodic pattern. In the third embodiment, the charging procedure, the exposing procedure, and the developing procedure, and the configuration of the image forming apparatus are the same as those of the second embodiment except the configuration of the photoconductive layer of the photosensitive drum 65, and the redundant description thereof will be omitted.

In the third embodiment, a light blocking layer having a similar periodic pattern along the rotation direction of the photosensitive drum 65 as illustrated in FIG. 13 is provided on the photoconductive layer of the photosensitive drum 65. In the third embodiment, according to the following processes, translucent portions and light shielding portions are alternately formed on the entire periphery of the photosensitive drum 65.

As illustrated in FIG. 22A, the insulating layer 101 and the photoconductive layer 102 are stacked on the aluminum substrate 100. As illustrated in FIG. 22B, the aluminum layer 103 is deposited on the photoconductive layer 102 by 100 nm, and the positive resist layer 104 is coated on the aluminum layer 103 by 1 μm. As illustrated in FIG. 22C, the positive resist layer 104 is exposed and developed using a line-and-space photomask of 5 μm/5 μm, so that the resist pattern 105 is formed on the aluminum layer 103. As illustrated in FIG. 22D, the aluminum layer 106 exposed from the resist pattern 105 is etched. As illustrated in FIG. 22E, a charge transfer layer 108 is coated to cover all of the resist pattern 105, the aluminum layer 106, and the photoconductive layer 102 by 15 μm through a dipping method.

As illustrated in FIG. 22E referring to FIG. 19, even when the portion where the resist pattern 105 and the aluminum layer 106 are left in the photoconductive layer of the photosensitive drum 65 is exposed by the scanning exposure unit 66, the light does not reach the photoconductive layer 102. Therefore, the charging potential is secured along with the periodic pattern without losing the charges through the photoconductive layer 102 even when being exposed. In the third embodiment, the photoconductive layer reduced in the surface charges by the exposure is blocked from the light according to the periodic pattern. In the third embodiment, since the photoconductive layer 102 is blocked from the light according to the periodic pattern, the electrostatic latent image of the image in which the patterned latent image is disposed in the entire image area is automatically formed after the ordinary exposure according to the image information by the scanning exposure unit 66.

In addition, in the third example, the influence of the duty cycle of the patterned latent image and the pitch between the neighboring patterns is similar to the first embodiment shown by Tables 1 and 2. The third embodiment is similar to the second embodiment in the reversal development system, and also similar in the relationship between the distribution of the electrostatic latent image and the force of the electric field formed by the electrostatic latent image operating on the toner. Therefore, even in the third embodiment, the duty cycle of the light area as the image portion of the patterned latent image is desirably 30% or more and less than 70%. In addition, the pitch of the patterned latent image is desirably 100% or more and less than 400% of the average particle diameter of the toner. In other words, in the case where the average particle diameter of the toner is 5 μm, the pitch of the patterned latent image is desirably 5 μm or more and less than 20 μm.

### Fourth Embodiment

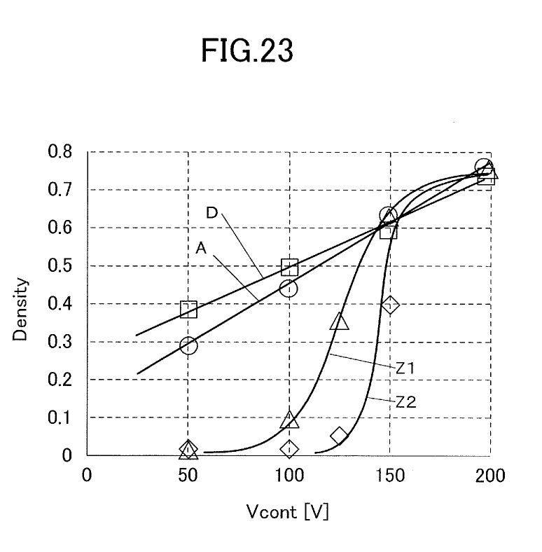

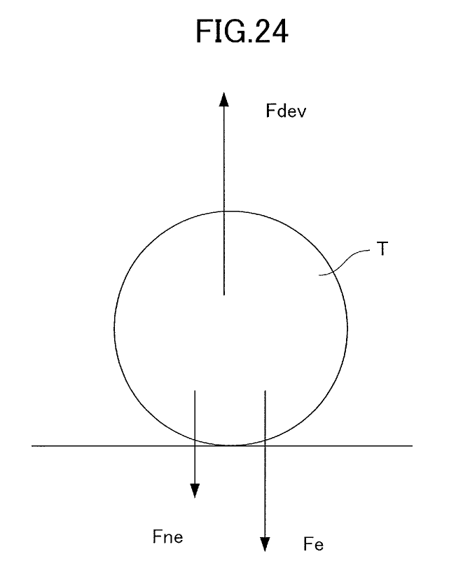

FIG. 23 is a graph illustrating a relationship between a development contrast and a concentration of the toner image in the fourth embodiment, and illustrates a comparison result between the apparatuses according to the first and fourth embodiments and the apparatus of the comparative example. FIG. 24 is a diagram schematically illustrating the force operated on the toner particle in the development process in which the AC voltage is not superimposed. In the fourth embodiment, the development is performed without applying the AC voltage to the developing sleeve 24 using the configuration similar to that of the first embodiment as illustrated in FIG. 2. The other configurations and the control are the same as those of the first embodiment, and the redundant description thereof will be omitted.

In the fourth embodiment, similarly to the first embodiment, the electrostatic latent image of the image having the patterned latent image is formed in the entire image area by overlapping the exposure of the scanning exposure unit 66 and the exposure of the masking exposure unit 61. Then, similarly to the first embodiment, by means of a two-component development system using the toner having the negative charged polarity, the electrostatic latent image is developed into the toner image on a development condition that the toner is movable in the unexposed portion of the image. However, in the fourth embodiment, the image is formed such that the electrostatic latent image is formed only by the DC voltage Vdc without superimposing the AC voltage Vac on the development voltage applied to the developing sleeve 24.

The solid image is formed by a toner application amount of 0.32 mg/cm2, which is equal to a desirable value in the first embodiment. Similarly to the first embodiment, the electrostatic latent image of the image is formed such that the average potential of the image area is set to +400 V and the average potential of the non-image area is set to +100 V. The potential difference between the DC voltage Vdc and the average potential of the image area is set into four stages of 50 V, 100 V, 150 V, and 200 V using the DC voltage Vdc (=+250 V) of the development voltage.

The first comparative example (Z1) illustrated in FIG. 23 shows a case where the patterned latent image is not formed in the electrostatic latent image of the image (the comparative example of FIG. 10). In the first comparative example, the electrostatic latent image of the image of the dark potential VD (=+420 V) and the light potential VL (=+100 V) is formed without forming the patterned latent image, and the DC voltage Vdc of the development voltage is set to +250 V to adjust the potential of the development contrast Vcont to 170 V. Therefore, the solid image of which the toner disposition amount is 0.32 mg/cm2 equal to the first embodiment is obtained. A second comparative example (Z2) shows, as similar to the fourth embodiment, a case where the AC voltage Vac is not superimposed on the development voltage applied to the developing sleeve 24 in the first comparative example.

As illustrated in FIG. 23, in the fourth embodiment (D), the image density is smoothly changed with respect to the variation of the development contrast compared to the first embodiment (A). On the other hand, similarly to the fourth embodiment, the non-linearity stronger than the first comparative example appears in the relationship between the development contrast and the image density in the second comparative example where the development is performed only by the DC voltage Vdc.

In the fourth embodiment, even on a low application condition such that the toner layer corresponds to about a single layer, it is possible to form the image which has good stability in the image density and is less reduced in chroma with respect to the variation of the development contrast Vcont compared to the first embodiment. In the case where only the DC voltage Vdc is used as the development voltage, the stability of the image density against the variation of the development contrast Vcont is remarkably increased by forming the patterned latent image in a superimposing manner as described in the first embodiment.

As illustrated in FIG. 24, the development starts when a development drive force Fdev acting on a toner particle T exceeds an electrostatic adhering force Fe of the toner with respect to the carrier. That is to say, the development is performed in a case when a force Fad applied to the toner in the following Equation is positive.

$$Fad = Fdev - Fe - Fne \\ Fdev = qE = 4 π {r}^{2} σ E \\ Fe = Ke \frac{{q}^{2}}{4 π {ɛ}_{0} {r}^{2}} = {Ke}^{′} 16 {π}^{2} {r}^{2} {σ}^{2} \\ Fne = Kv \cdot r \\ Fad = 4 π {r}^{2} σ E - {Ke}^{′} 16 {π}^{2} {r}^{2} {σ}^{2} - Kv \cdot r \qquad Equation 2$$

Herein, Fdev indicates the development drive force, Fe indicates the electrostatic adhering force, and Fne indicates a non-electrostatic adhering force. q indicates a charge amount of the toner, r indicates a radius of the toner, σ indicates a charge density on the toner surface, and E indicates a field intensity applied on the toner. Ke and KV are parameters obtained by actually measuring the electrostatic adhering force and the non-electrostatic adhering force, respectively.

In the second comparative example, since the development voltage is the DC voltage Vdc, it is considered that a field intensity E applied to the toner becomes small so as to increase the influence on the non-linearity. On the contrary, in the fourth embodiment, since the field intensity on the surface of the photosensitive drum 65 is increased and thus a strong binding force is applied to the closed toner particles of one layer as illustrated in FIG. 17A, it is convincible that the non-linearity hardly affects even when the AC voltage is not superimposed.

### OTHER EMBODIMENTS

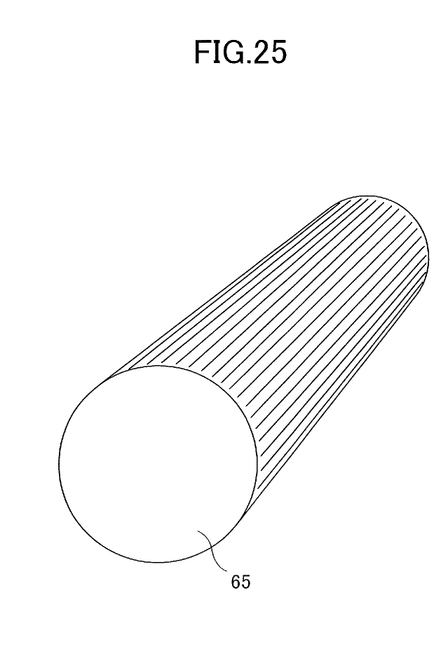

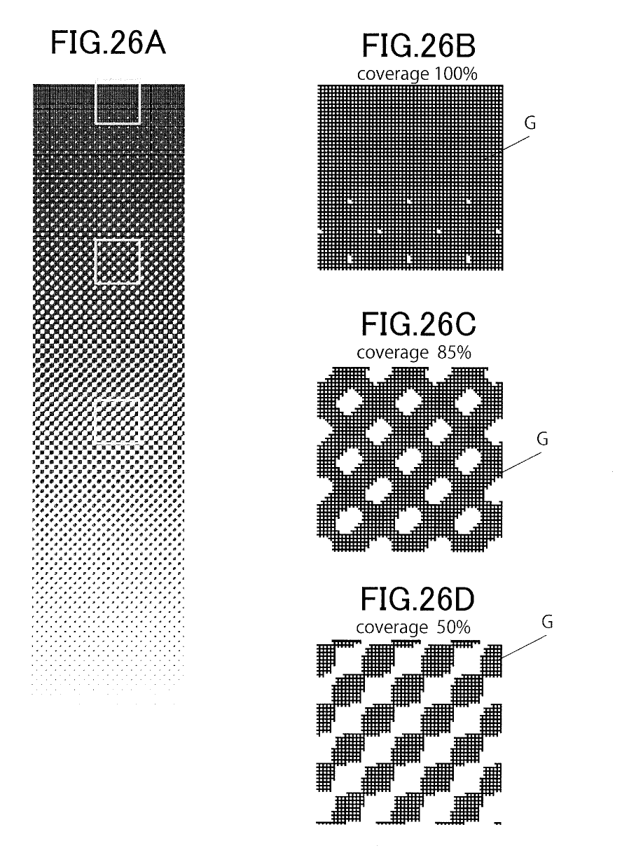

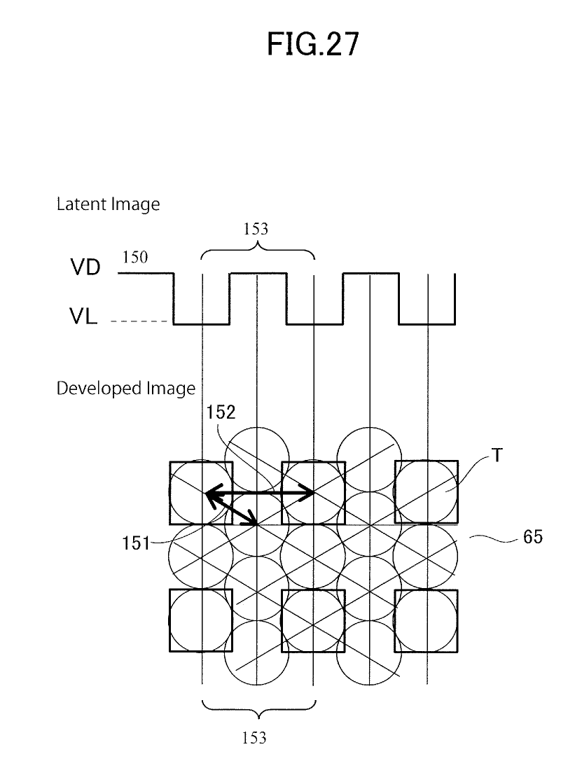

FIG. 25 depicts another arrangement of the patterned latent image different from those of the first to fourth embodiments. FIGS. 26A to 26D illustrate still another arrangement of the patterned latent image. FIG. 27 illustrates a positional relationship between the toner particles and the patterned latent image. This technique can be implemented even to other embodiments in which some or all of the configurations of the embodiments are replaced with alternatives thereof, as long as the electrostatic latent image containing a periodic patterned latent image is developed into a toner image such that the patterned latent image is covered with the toner. There is no purpose of limiting dimensions, materials, shapes, and relative arrangement of components described in the examples to those in the scope of this disclosure if not otherwise specified.

As illustrated in FIG. 13, the first to third embodiments have been described about the stripe pattern in which the periodic patterns of the electrostatic latent image are arranged in the direction of the rotational axis of the photosensitive drum 65. However, as illustrated in FIG. 25, the stripe pattern may be configured such that the linear areas parallel to the rotational axis of the photosensitive drum 65 are arranged in the rotation direction of the photosensitive drum 65, for example.

As illustrated in FIG. 6, in the first to third embodiments, the patterned latent image of the stripe pattern is disposed in the entire image area G in the electrostatic latent image of the image. However, the periodic pattern of the patterned latent image is not limited to the stripe pattern. As illustrated in FIG. 26, the patterned latent image of a dot pattern in which dots of exposed sections may be disposed in the entire image area G in the electrostatic latent image of the image. As illustrated in FIG. 27, the electric field is formed between the dot and the periphery thereof so that the toner particle T is held on the dot. In this case, a width direction intersecting the periodic pattern means a direction intersecting the dots, that is, a direction along a line passing through the adjacent dots.

As described in the fourth embodiment, there may be employed the developing method in which the AC voltage is not applied between the image bearing member and the developer bearing member. The image forming apparatus may be implemented by a contact developing system in which charged toner carried by a rubber roller comes in contact with the image bearing member to develop the electrostatic latent image. The pattern of the patterned latent image formed in the electrostatic latent image is not limited to the stripe shape.

The corona charger 63 and the masking exposure unit 61 can be taken as an example of the charging unit. These apparatuses uniformly charge the area where the toner image of the photosensitive drum 65 can be formed and then neutralize the surface of the photosensitive drum 65 according to the periodic pattern, so that the potential distribution according to the periodic pattern is formed.

In addition, this technique may be implemented using a photoconductor which is not rotatable (for example, a plate photoconductive member).

The image forming apparatus may be implemented without distinction of one-drum/tandem type. The image forming apparatus may be implemented without distinction of the number of photoconductive members, the charging method, the forming method of the electrostatic latent image, the transferring method, and the fixing method. The image forming apparatus may be implemented by various applications of image forming apparatuses such as a printer, various types of printing machines, a copier, a FAX, a multifunction peripheral by adding necessary machines, equipment, and casing structures.

It has been experimentally confirmed that an electrostatic latent image of the image on which a patterned latent image is superimposed has an application amount of toner per unit area larger than that of the certain conventional electrostatic latent image on which the patterned latent image is not superimposed when the development contrast is lowered. The variation in the toner application amount per unit area becomes small at every place in the area having a constant development contrast by superimposing the patterned latent image on the electrostatic latent image of the image (FIG. 10). By means of superimposing the patterned latent image on the electrostatic latent image, the developed image is prevented from the unevenness of image density even when the development contrast is lowered (Table 1). Such a result is obtained even in a case where the photoconductive member is configured to have the periodic pattern by providing the light blocking layer for blocking the photoconductive layer or by forming the photoconductive layer to have the stripe shape, as in the second and third embodiments.

Therefore, this disclosure provides an image forming apparatus in which the unevenness of density hardly occurs in a colored area of the image even when setting a low development contrast.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2015-080166, filed Apr. 9, 2015, which is hereby incorporated by reference herein in its entirety.

What is claimed is:

1. An image forming apparatus comprising:
a photoconductor;
a charging unit configured to charge a surface of the photoconductor;
an exposure unit configured to expose the photoconductor charged by the charging unit so as to form a electrostatic latent image comprising a printing latent image corresponding to an image information to be printed and a patterned latent image, the patterned latent image comprising exposed sections exposed by the exposure unit and unexposed sections less exposed than the exposed sections, the exposed sections and the unexposed sections being disposed alternately to form a periodic pattern; and
a developing unit configured to develop the electrostatic latent image formed on the photoconductor by the exposure unit with toner,
wherein each of the exposed sections occupies 30% or more and 70% or less of an area of one period of the patterned latent image, and a period of the patterned latent image in a width direction intersecting the periodic pattern is within a range of 100% or more and less than 400% of an average particle diameter of the toner.

2. The image forming apparatus according to claim 1, wherein the exposure unit comprises
a first exposure unit configured to expose the photoconductor with light emitted from a first light source so as to form the printing latent image, and
a second exposure unit configured to expose the photoconductor with light emitted from a second light source so as to form the patterned latent image.

3. The image forming apparatus according to claim 1,
wherein the second exposure unit comprises a light shielding member with translucent portions through which the photoconductor is irradiated, the translucent portions being disposed in accordance with the exposed sections of the patterned latent image.

4. The image forming apparatus according to claim 1,
wherein the exposure unit comprises a light shielding member provided with translucent portions through which the photoconductor is irradiated, the translucent portions being disposed in accordance with the exposed sections of the patterned latent image.

5. An image forming apparatus comprising:
a photoconductor;
a charging unit configured to charge a surface of the photoconductor;
an exposure unit configured to expose the surface of the photoconductor charged by the charging unit so as to form an electrostatic latent image corresponding an image information; and
a developing unit configured to develop the electrostatic latent image on the photoconductor with toner,
wherein the photoconductor comprises first areas configured to become conductive by being exposed by the exposure unit and second areas configured to remain approximately non-conducting upon exposed, the first areas and the second areas being disposed alternately to form a periodic pattern, and
wherein each of the first areas occupies 30% or more and 70% or less of an area of one period of the periodic pattern, and a period of the periodic pattern in a width direction intersecting the periodic pattern is within a range of 100% or more and less than 400% of an average particle diameter of the toner.

6. The image forming apparatus according to claim 5,
wherein the photoconductor comprises a photoconductive layer being formed in accordance with the periodic pattern and configured to dissipate surface charge by being exposed.

7. The image forming apparatus according to claim 5,
wherein the photoconductor comprises a photoconductive layer configured to dissipate surface charge by being exposed and a blocking layer formed so as to block the exposure of the photoconductive layer in accordance with the periodic pattern.

8. The image forming apparatus according to claim 1,
wherein the patterned latent image is a stripe pattern in which the exposed sections and the unexposed sections are formed into stripes arranged in parallel.

9. The image forming apparatus according to claim 8,
wherein the photoconductor is rotatable, and
wherein the stripes of the stripe pattern are formed to extend along a rotation direction of the photoconductor and are arranged in a direction of a rotational axis of the photoconductor.

10. The image forming apparatus according to claim 1,
wherein the developing unit comprises a developer bearing member configured to bear developer and to be charged at a development potential so as to develop the electrostatic latent image on the photoconductor into a toner image, and
wherein the average particle diameter of the toner of the developer is 4 μm or more and less than 8 μm, and a potential difference between the development potential and an average potential of an area on the photoconductor to be developed with the toner is set to 150 V or less.

11. The image forming apparatus according to claim 5,
wherein the periodic pattern is a stripe pattern in which the first areas and the second areas are formed into stripes arranged in parallel.

12. The image forming apparatus according to claim 11,
wherein the photoconductor is rotatable, and
wherein the stripes of the stripe pattern are formed to extend along a rotation direction of the photoconductor and are arranged in a direction of a rotational axis of the photoconductor.

13. The image forming apparatus according to claim 5,
wherein the developing unit comprises a developer bearing member configured to bear developer and to be charged at a development potential so as to develop the electrostatic latent image on the photoconductor into a toner image, and
wherein the average particle diameter of the toner of the developer is 4 μm or more and less than 8 μm, and a potential difference between the development potential and an average potential of an area on the photoconductor to be developed with the toner is set to 150 V or less.
